(19) United States
(12) Patent Application Publication
(10) Pub. No.: US 2026/0303169 A1
(43) Pub. Date: Oct. 1, 2026

(54) DEVICES AND METHODS FOR COMMUNICATION

(71) Applicant: NEC Corporation, Tokyo (JP)

(72) Inventors: Yukai GAO, Beijing (CN); Peng GUAN, Beijing (CN); Lin LIANG, Beijing (CN); Gang WANG, Beijing (CN)

(73) Assignee: NEC Corporation, Tokyo (JP)

(21) Appl. No.: 19/477,826

(22) PCT Filed: Apr. 24, 2023
(86) PCT No.: PCT/CN2023/090441

§ 371 Date: Oct. 23, 2025

(51) Int. Cl. H04B 7/06

(52) U.S. Cl. CPC H04B 7/0626

(57) ABSTRACT

Embodiments of the present disclosure provide a solution for configurating and transmitting channel information. In the solution, a first node receives, from a second node or a function entity, at least one first message for sensing; and perform, based on the at least one first message, at least one of the following: transmitting, at least one second message to at least one of the second node or the function entity; or transmitting, to the second node, a second set of RSs to be measured by the second node to generate at least one third message comprising information used for sensing.

### FIELDS

Example embodiments of the present disclosure generally relate to the field of communication techniques and in particular, to devices and methods for configuring and transmitting channel information.

### BACKGROUND

Technology of multiple input multiple output (MIMO) has been widely used in current wireless communication system, where a large number of antenna elements are used by a network device for communicating with a terminal device for both sub-6 GHZ and over-6 GHz frequency bands.

Further, technology of integrated sensing and communication (ISAC) has been agreed as a feature to be supported in the future communication. However, requirements for sensing and communication are different, especially for the scenario of MIMO. Thus, how to configure and transmit channel information to enable sensing is desirable to be discussed.

### SUMMARY

In general, embodiments of the present disclosure provide a solution for configurating and transmitting channel information.

In a first aspect, there is provided a first node comprising: a processor configured to cause the first node to: receive, from a second node or a function entity, at least one first message for sensing; and perform, based on the at least one first message, at least one of the following: transmitting, at least one second message to at least one of the second node or the function entity, the at least one second message comprising information used for sensing, the at least one second message being determined by the first node by measuring a first set of reference signals (RSs) transmitted by the second node; or transmitting, to the second node, a second set of RSs to be measured by the second node to generate at least one third message comprising information used for sensing.

In a second aspect, there is provided a second node comprising: a processor configured to cause the second node to: receive from a function entity or transmit to a first node, at least one first message for sensing; and perform at least one of the following: receiving, from the first node, at least one second message, the at least one second message comprising information used for sensing, the at least one second message being determined by the first node by measuring a first set of reference signals (RSs) transmitted by the second node; transmitting, to the first node or the function entity, at least one third message comprising information used for sensing, the at least one third message being determined by the second node by measuring a second set of RSs transmitted by the first node based on the at least one first message.

In a third aspect, there is provided a function entity comprising: a processor configured to cause the function entity to: transmit, to at least one of a first node or a second node, a first message for sensing; and receive, at least one of following: at least one second message comprising information used for sensing from the first node, the at least one second message being determined by the first node by measuring a first set of reference signals (RSs) transmitted by the second node; at least one third message comprising information used for sensing from the second node, the at least one third message being determined by the second node by measuring a second set of RSs transmitted by the first node based on the at least one first message.

In a fourth aspect, there is provided a communication method performed by a first node. The method comprises: receiving, from a second node or a function entity, at least one first message for sensing; and performing, based on the at least one first message, at least one of the following: transmitting, at least one second message to at least one of the second node or the function entity, the at least one second message comprising information used for sensing, the at least one second message being determined by the first node by measuring a first set of reference signals (RSS) transmitted by the second node; or transmitting, to the second node, a second set of RSs to be measured by the second node to generate at least one third message comprising information used for sensing.

In a fifth aspect, there is provided a communication method performed by a second node. The method comprises: receiving from a function entity or transmit to a first node, at least one first message for sensing; and performing at least one of the following: receiving, from the first node, at least one second message, the at least one second message comprising information used for sensing, the at least one second message being determined by the first node by measuring a first set of reference signals (RSS) transmitted by the second node; transmitting, to the first node or the function entity, at least one third message comprising information used for sensing from the second node, the at least one third message being determined by the second node by measuring a second set of RSs transmitted by the first node based on the at least one first message.

In a sixth aspect, there is provided a communication method performed by a function entity. The method comprises: transmitting, to at least one of a first node or a second node, a first message for sensing; and receiving, at least one of following: at least one second message comprising information used for sensing from the first node, the at least one second message being determined by the first node by measuring a first set of reference signals (RSS) transmitted by the second node; at least one third message comprising information used for sensing, the at least one third message being determined by the second node by measuring a second set of RSs transmitted by the first node based on the at least one first message.

In a seventh aspect, there is provided a computer readable medium having instructions stored thereon, the instructions, when executed on at least one processor, causing the at least one processor to carry out the method according to the fourth, fifth, or sixth aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1A illustrates an example communication environment in which example embodiments of the present disclosure can be implemented;

FIG. 1B illustrates another example communication environment in which example embodiments of the present disclosure can be implemented;

FIG. 2A illustrates a signaling flow of communication in accordance with some embodiments of the present disclosure;

FIG. 2B illustrates another signaling flow of communication in accordance with some embodiments of the present disclosure;

FIG. 3A illustrates an example communication scenario;

FIG. 3B illustrates example second information;

FIG. 3C illustrates an example measurement report;

FIG. 4A illustrates example second information;

FIG. 4B illustrates an example measurement report;

FIG. 5A illustrates an example communication scenario;

FIG. 5B illustrates example second information;

FIG. 6 illustrates example second information;

FIG. 7 illustrates example second information;

FIG. 8A illustrates a flowchart of a method implemented at a first device according to some example embodiments of the present disclosure;

FIG. 8B illustrates a flowchart of a method implemented at a second device according to some example embodiments of the present disclosure;

FIG. 9A illustrates a flowchart of a method implemented at a first node according to some example embodiments of the present disclosure;

FIG. 9B illustrates a flowchart of a method implemented at a first node according to some example embodiments of the present disclosure;

FIG. 9C illustrates a flowchart of a method implemented at a function entity according to some example embodiments of the present disclosure;

FIG. 10 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g., FR1 (e.g., 450 MHz to 6000 MHz), FR2 (e.g., 24.25 GHz to 52.6 GHz), frequency band larger than 100 A GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, channel emulator. In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As used herein, the term “resource,” “transmission resource,” “uplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As discussed above, technology of ISAC has been agreed as a feature to be supported in the future communication. Generally speaking, measuring reference signal (RS) is a necessary operation for both sensing and communication. However, the requirements of the measurement report used for sensing and the requirements of measurement report used for communications are different.

Specifically, as for MIMO scenario, the MIMO channel may be decomposed into spatial domain (SD, which may be identified by angle, beam, SD vector and so on), frequency domain (FD, which may be identified by FD vector or delay information and so on).

The delay information may be useful for both communication and sensing (at least in case of sensing a target object based on a transmitter and a receiver). However, absolute delay is not needed for communication (such as, calculating the precoder or channel quality indicator, CQI), while it is needed for sensing.

In view of this, in order to achieve ISAC based on MIMO, further enhancements for measuring and reporting the RSs, especially for how to measure/quantize the delay, is needed.

According to the present disclosure, a solution for configuring and transmitting the measurement report to achieve ISAC is proposed. In this solution, the first device (such as, a terminal device) receives configuration information for at least one measurement report from a second device (such as, a network device). Based on the first configuration information, the first device transmits the at least one measurement report to the second device. The at least one measurement report may indicate at least one of the following: a first set of first information related to SD, a second set of second information related to FD or timing information for path, a third set of amplitude coefficients, a fourth set of phase coefficients, or a fifth set of timing information for a set of rays associated with one second information in the second set of second information.

In particular, the at least one measurement report may comprise a first subset of information and a second subset of information, wherein the first or the second subset of information is applied for a calculation/report of precoder or CQI. Alternatively, or in addition, the at least one measurement report may comprise a first measurement report and a second measurement report associated with the first measurement report.

In this way, the at least one measurement report may be used for both sensing and communication (e.g., the calculation/report of precoder or CQI or PMI or CSI).

It is to be understood that the scenario of ISAC would be especially benefit from the example embodiments of the present disclosure. However, it does not mean that the example embodiments of the present disclosure can be implemented only for this specific scenario. Actually, the example embodiments of the present disclosure may be implemented in any scenario where at least one measurements report is associated with at least two different functionalities. The present disclosure is not limited in this regard.

Further, due to sensing has been agreed as a feature supported in the 5GC system, thus, more network elements, including terminal device, network device (such as, a next generation eNodeB (ng-eNB), or a gNB in the next generation radio access network (NG-RAN)), 5GC function (such as, an access and mobility management function (AMF), an integrated sensing management function (ISMF), a sensing function (SF) or a location management function (LMF)) and other third-party entity (such as, a sensing service requester), are involved in the sensing measurement. In view of this, how to communicate signalling(s)/message(s) among these network elements are also desirable to be further discussed.

According to the present disclosure, a solution for configuring and transmitting channel information is proposed. In this solution. The first node receives at least one first message for sensing from a second node or a function entity. Then, the first node transmits at least one second message to at least one of the second node or the function entity, where the at least one second message comprises information used for sensing and the at least one second message is determined by the first node by measuring a first set of RSs transmitted by the second node. Alternatively, the first node transmits a second set of RSs to the second node, such that the second node may generate at least one third message comprising information used for sensing.

In summary, by communicating the first message, the second message and/or the third message, the first/second node may obtain the sensing signals and sensing measurements. As a result, sensing feature may be well supported in the 5GC network.

As used herein, the terms “UE expects”, “UE does not expect, “terminal device expects”, “terminal device does not expect” may imply restrictions on a configuration of a network device (also referred to as NW configuration). The terms “UE is not expected to” and “terminal device is not expected to” may imply a terminal implementation, also referred to as UE implementation. In some embodiments, the terms “UE does not expect” and “UE is not expected to” may be used equally.

For better descriptions, some terms used herein are listed as below:
a set of first/third/fourth/fifth information related to SD: the first/third/fourth/fifth information may be an information item comprised in the first set, which may be at least one of: an SD vector, one CSI-RS port, an azimuth angle of departure, an angle of departure (AoD), an azimuth angle of departure (AoD), a zenith angle of departure (ZoD), an azimuth angle of arrival, an angle of arrival (AoA), a zenith angle of departure (ZoA), an angle of a directional angle, a beam for reception, a beam for transmission, an SD filter for reception, an SD filter for transmission and other SD-related parameter;
a set of second information related to FD or timing information for path: the second information may be an information item comprised in the second set, which may be at least one of: an FD vector, or a timing information for a path (for example, an absolute time/delay value, a differential time/delay time value); Further, the second information may be a delay/timing for a cluster/path, in terms of nanosecond (ns) and/or microsecond (us) and/or millisecond (ms) and/or meter (m);
first time information: refers to the timing for the second information (or the reference second information). For example, first time information may be represented as an absolute time value;
second time information: refers to timing for a ray corresponding to one second information. For example, second time information may be represented as a differential time value;
third time information: refers to the timing for the second information. For example, third time information may be represented as a differential time value (e.g., may be a differential value between a time value of the respective second information and the first time information);
a cluster: refers to a set of rays.

As used herein, a set of rays may correspond to one second time information and/or at least one of: a path, a cluster and a delay.

As used herein, a function entity may be a 5GC feature/function, including but are not limited to an AMF, ISMF, SF, LMF and any suitable 5GC feature/function.

As used herein, terms “signaling”, “message”, “configuration”, “request”, “response”, “information” and “signal”, “packet” may be used interchangeably.

As used herein, the terms “node”, “device”, “apparatus” “function” and “function entity” may be used interchangeably.

As used herein, the terms “precoder”, “precoding”, “precoding matrix”, “beam”, “beamforming”, “vector”, “basis”, “first vector”, “first basis”, “first basis vector”, “codebook”, “UL codebook”, “spatial domain-related information”, “SD-related information”, “spatial relation information”, “spatial relation info”, “precoding information”, “precoding information and number of layers”, “precoding matrix indicator (PMI)”, “precoding matrix indicator”, “transmission precoding matrix indication”, “precoding matrix indication”, “transmission configuration indication state (TCI state)”, “UL TCI state”, “joint TCI state”, “transmission configuration indicator”, “quasi co-location (QCL)”, “quasi-co-location”, “QCL parameter”, “QCL assumption”, “QCL relationship” and “spatial relation” may be used interchangeably.

As used herein, the terms “vector”, “vectors”, “bases” and “basis” may be used interchangeably.

As used herein, the terms “functionality” and “usage” may be used interchangeably.

As used herein, the terms “subset of information”, “subset of measurement”, “subset of measurement report”, “part of measurement report”, “report”, “measurement” and “measurement report” may be used interchangeably.

As used herein, the terms “first subset of information”, “first subset of measurement”, “first subset of measurement report”, “first part of measurement report”, “first report”, “first measurement” and “first measurement report” may be used interchangeably.

As used herein, the terms “second subset of information”, “second subset of measurement”, “second subset of measurement report”, “second part of measurement report”, “second report”, “second measurement” and “second measurement report” may be used interchangeably.

As used herein, the terms “first vector”, “a SRS port”, “a CSI-RS port”, “an RS port”, “a SRS resource”, “a CSI-RS resource”, “an RS resource”, “an antenna port”, “first beam”, “beam”, “first bases”, “first basis vector”, “spatial domain/SD basis vector”, “spatial domain/SD vectors”, “spatial domain/SD basis”, “spatial domain/SD bases”, “spatial domain/SD basis vectors corresponding to a TRP index”, “spatial domain/SD vectors corresponding to a TRP index”, “spatial domain/SD basis corresponding to a TRP index”, “spatial domain/SD bases corresponding to a TRP index”, “first basis corresponding to a TRP index”, “spatial domain-related information”, “SD-related information”, “spatial relation information”, “spatial relation info”, “an azimuth angle of departure”, “an angle of departure”, “AoD”, “a zenith angle of departure”, “ZoD”, “an angle of a directional angle”, “an azimuth angle of arrival”, “an angle of arrival”, “AoA”, “a zenith angle of departure”, “ZoA” and “first basis” may be used interchangeably.

As used herein, the terms “second vector”, “second basis”, “frequency domain/FD basis vector”, “frequency domain/FD vector”, “frequency domain/FD basis”, “frequency domain/FD bases”, “second bases”, “frequency domain-related information”, “FD-related information”, “second vector corresponding to a TRP index”, “second bases corresponding to a TRP index”, “frequency domain/FD basis vectors corresponding to a TRP index”, “frequency domain/FD vectors corresponding to a TRP index”, “frequency domain/FD basis corresponding to a TRP index”, “frequency domain/FD bases corresponding to a TRP index” and “second basis corresponding to a TRP index” may be used interchangeably.

As used herein, the terms “index”, “indicator”, “indication”, “field”, “bit field” and “bitmap” may be used interchangeably.

As used herein, the terms “delay”, “path”, “cluster” and “second information” may be used interchangeably.

As used herein, the terms “bit size”, “size of bits”, “number of bits”, “size of field”, “bitwidth” and “field size” may be used interchangeably.

As used herein, the terms “element of indication field”, “parameter” and “indication” may be used interchangeably. As used herein, the terms “associated with”, “corresponding to”, “correspond to” and “comprise” may be used interchangeably.

Principles and implementations of the present disclosure will be described in detail below with reference to the figures.

### Example Environment

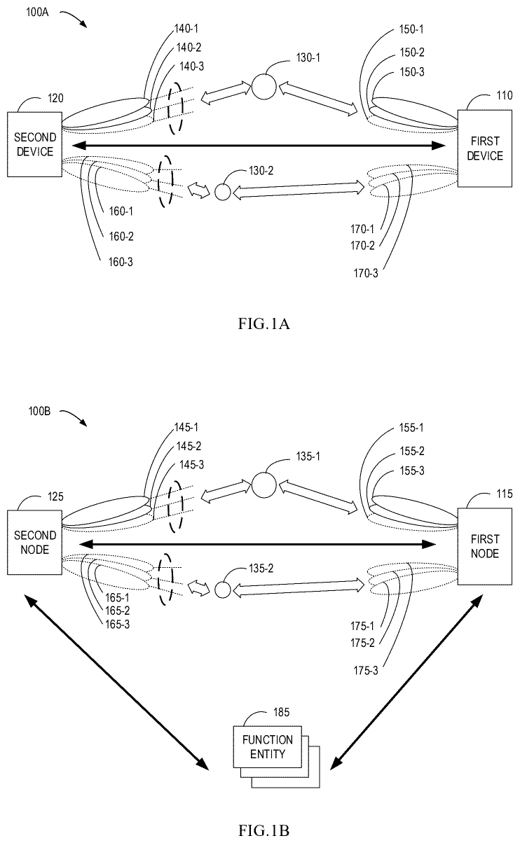

FIG. 1A illustrates an example communication environment 100A in which example embodiments of the present disclosure can be implemented. The communication environment 100A includes a first device 110 and a second device 120.

In some example embodiments, the first device 110 may be comprised in a terminal device/apparatus and the second device 120 may be comprised in a network device/apparatus serving the terminal device/apparatus.

In the following, for the purpose of illustration, some example embodiments are described with the first device 110 operating as a terminal device and the second device 120 operating as a network device. However, in some example embodiments, operations described in connection with a terminal device may be implemented at a network device or other device, and operations described in connection with a network device may be implemented at a terminal device or other device.

In some example embodiments, if the first device 110 is a terminal device and the second device 120 is a network device, a link from the second device 120 to the first device 110 is referred to as a downlink (DL), while a link from the first device 110 to the second device 120 is referred to as an uplink (UL). In DL, the second device 120 is a transmitting (TX) apparatus (or a transmitter) and the first device 110 is a receiving (RX) apparatus (or a receiver). In UL, the first device 110 is a TX apparatus (or a transmitter) and the second device 120 is a RX apparatus (or a receiver).

Further, MIMO is supported by at least one of the first device 110 and the second device 120. As illustrated in FIG. 1A, the first device 110 may use at least one of: beams 150-1, 150-2, 150-3 (individually or collectively referred to as a beam 150) and beams 170-1, 170-2, 170-3 (individually or collectively referred to as a beam 170) to communicate with the second device 120. Accordingly, 1, the second device 120 may use at least one of: beams 140-1, 140-2, 140-3 (individually or collectively referred to as a beam 140) and beams 160-1, 160-2, 160-3 (individually or collectively referred to as a beam 160) to communicate with the first device 110.

Further, the communication environment 100A comprises objects 130-1 and 130-2, collectively referred to as object(s) 130 or individually referred to as a first object 130-1 and a second object 130-2. According to the example embodiments of the present disclosure, the object(s) 130 may be sensed by the first device 110 and/or the second device 120.

In some embodiments, the first device 110 may transmit measurement report(s) to the second device 120. By communicating the measurement report(s), ISAC may be achieved in the communication environment 100A. Such procedure will be discussed in detail in the following text.

It is to be understood that the number of devices and their connections shown in FIG. 1A are only for the purpose of illustration without suggesting any limitation. The communication environment 100A may include any suitable number of devices configured to implementing example embodiments of the present disclosure.

In some embodiments, the first device 110 and the second device 120 may communicate with each other via a channel such as a wireless communication channel on an air interface (e.g., Uu interface). The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

Another communication environment 100B in which example embodiments of the present disclosure can be implemented is illustrated in FIG. 1B. The communication environment 100A includes a first node 115, a second node 125 and a function entity 185.

In some example embodiments, the first node 115 may be comprised in a terminal device or a network device, the second node 125 may be comprised in a network device, and the function entity 185 may be in at least one of an AMF, an ISMF, an SF or an LMF.

Further, MIMO is supported by at least one of the first node 115 and the second node 125. As illustrated in FIG. 1B, the first node 115 may use at least one of: beams 155-1, 155-2, 155-3 (individually or collectively referred to as a beam 155) and beams 175-1, 175-2, 175-3 (individually or collectively referred to as a beam 175) to communicate with the second node 125. Accordingly, 1, the second node 125 may use at least one of: beams 145-1, 145-2, 145-3 (individually or collectively referred to as a beam 145) and beams 165-1, 165-2, 165-3 (individually or collectively referred to as a beam 165) to communicate with the first node 115.

Further, the communication environment 100B comprises objects 135-1 and 135-2, collectively referred to as object(s) 135 or individually referred to as a first object 135-1 and a second object 135-2. According to the example embodiments of the present disclosure, the object(s) 135 may be sensed by the first node 115 and/or the second node 125.

Further, as illustrated in FIG. 1B, message(s)/information/signaling(s) may be interacted/communicated between the first node 115 and the second node 125 and/or the function entity 185.

The communications in the communication environment 100A and 100B may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

### Example Processes

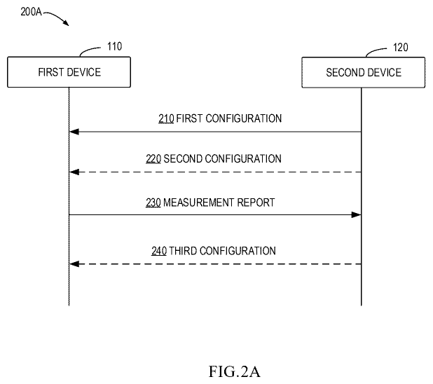

Reference is made to FIG. 2A, which illustrates a signaling flow 200A of communication in accordance with some embodiments of the present disclosure. For the purposes of discussion, the signaling flow 200A will be discussed with reference to FIG. 1A, for example, by using the first device 110 and the second device 120.

It is to be understood that the operations at the first device 110 and the second device 120 should be coordinated. In other words, the second device 120 and the first device 110 should have common understanding about configurations, parameters and so on. Such common understanding may be implemented by any suitable interactions between the second device 120 and the first device 110 or both the second device 120 and the first device 110 applying the same rule/policy. In the following, although some operations are described from a perspective of the first device 110, it is to be understood that the corresponding operations should be performed by the second device 120. Similarly, although some operations are described from a perspective of the second device 120, it is to be understood that the corresponding operations should be performed by the first device 110. Merely for brevity, some of the same or similar contents are omitted here.

In addition, in the following description, some interactions are performed among the terminal device 110 and the network device 120 (such as, exchanging configuration(s) and so on). It is to be understood that the interactions may be implemented either in one single signaling/message/configuration or multiple signaling/messages/configurations, including system information, radio resource control (RRC) message, downlink control information (DCI) message, uplink control information (UCI) message, media access control (MAC) control element (CE) and so on. The present disclosure is not limited in this regard.

In some embodiments, the first device 110 may be operated as a terminal device and the second device 120 may be operated as a network device.

In some embodiments, the first device 110 may receive first configuration information of at least one measurement report from a second device 120. Based on the first configuration information, the first device 110 may transmit 230 at least one measurement report to the second device 120. The at least one measurement report may indicate at least one of the following:
a first set of first information related to SD,
a second set of second information related to FD or timing information for path,
a third set of amplitude coefficients,
a fourth set of phase coefficients, or
a fifth set of timing information for a set of rays associated with one second information in the second set of second information.

In some embodiments, the second device 120 may transmit at least one first configuration to the first device 110. The at least one first configuration may indicate information and/or a set of resources for an RS. In some embodiments, the RS may be a downlink RS. For example, the RS may be any one or more of a demodulation reference signal (DMRS), a cell reference signal (CRS), a multicast broadcast single frequency network (MBSFN) reference signal, a positioning reference signal (PRS), a fine time/frequency tracking reference signal (TRS), a phase tracking reference signal (PTRS), a channel state information-reference signal (CSI-RS), a CSI-RS for tracking, a sensing reference signal, and a CSI-RS for mobility.

In some embodiments, the RS may be an uplink RS. For example, the RS may be any one or more of a sounding reference signal (SRS), a demodulation reference signal (DMRS), a positioning reference signal (PRS), a fine time/frequency tracking reference signal (TRS), a sensing reference signal and a phase tracking reference signal (PTRS). It should be noted that the RS may be any downlink or uplink reference signal existing in the art or to be developed in the future.

In some embodiments, the first configuration information may be at least one first configuration. In some embodiments, the first configuration information may comprise at least one of: measurement report quantity, measurement report identity (ID), the number of first information comprised in the first set, the number of second information comprised in the second set, number of antenna ports for the RS, number of resources for the RS, time domain behavior for the RS (For example, periodic, semi-persistent and aperiodic), periodicity for the RS, slot offset for the RS, starting symbol index in a slot for the RS, number of symbols in a slot for the RS, frequency domain resource location for the RS, time domain resource for the RS and frequency resource for the RS.

In some embodiments, the at least one measurement report may comprise a first subset of information and a second subset of information, wherein one of the first and second subsets of information may be applied for a calculation/report of precoder and/or CQI and/or PMI and/or CSI. In some embodiments, the at least one measurement report may comprise a first measurement report and a second measurement report associated with the first measurement report.

In some embodiments, the precoder may be calculated by below Equation (1):

$$\begin{matrix}\tilde{W} = {W}_{1} * {W}_{2} * {( {W}_{f} )}^{H} \\ = [ \begin{matrix}{v}_{0} {v}_{1} … {v}_{L - 1} & 0 \\ 0 & {v}_{0} {v}_{1} … {v}_{L - 1}\end{matrix} ] * {W}_{2} * \\ [ \begin{matrix}{y}_{0}^{( 0 )} & {y}_{1}^{( 0 )} & … & {y}_{{N}_{3} - 1}^{( 0 )} \\ {y}_{0}^{( 1 )} & {y}_{1}^{( 1 )} & … & {y}_{{N}_{3} - 1}^{( 1 )} \\ ⋮ & ⋮ & ⋮ & ⋮ \\ {y}_{0}^{( {M}_{v} - 1 )} & {y}_{1}^{( {M}_{v} - 1 )} & … & {y}_{{N}_{3} - 1}^{( {M}_{v} - 1 )}\end{matrix} ]\end{matrix} \qquad Equation ( 1 )$$

In some embodiments, in Equation (1), W₁ may be the set of first vectors or the first set of first information or set of CSI-RS ports or set of SRS ports. In some embodiments, in Equation (1), W_{f} may be the second set of second information or the set of second vectors. In some embodiments, in Equation (1), W₂ may be the third set of amplitude coefficients and/or the fourth set of phase coefficients.

In some embodiments, the number of first information comprised in the first set may be represented as L, where L may be positive integer. For example, 1<=L<=16. For another example, L may be at least one of {1, 2, 4, 6, 8}.

In some embodiments, the number of second information comprised in the second set may be represented as M, where M may be positive integer. For example, 1<=M<=18.

In some embodiments, parameters L and M may be indicated by the first configuration information. In some embodiments, the first configuration information may indicate at least one of the following: the number of first information comprised in the first set, the number of second information comprised in the second set. Alternatively, or in addition, in some embodiments, the first configuration information may indicate the (maximum) number of amplitude coefficients comprised in the third set, or the (maximum) number of phase coefficients in the fourth set.

It should be understood that the first configuration information may indicate any suitable parameter/information associated with the measurement report, including but not limited to, recourses used for reporting the measurement reports. The present disclosure is not limited in this regard.

In some embodiments, the first information may be at least one of: an SD vector, one CSI-RS port, an angle of departure, an AoD, a ZoD, an AoA, a ZoA, an angle of a directional angle or a beam. For example, in this way, the spatial information may be well represented. In some embodiments, the second information may at least one of: an FD vector, or a timing information for a path (such as, a delay or a cluster). For example, in this way, the second device 120 may obtain information about both sensing and communication.

In the following, details about how to indicate the second information will be discussed.

In some embodiments, each second information comprised in the second set may be indicated by or associated with an absolute time value and/or a differential time value.

In some embodiments, one of the second information comprised in the second set may be indicated as reference second information. In some embodiments, the at least one measurement report may further indicate the reference second information.

In some embodiments, the reference second information may be indicated or comprised in the at least one measurement report, and other second information in the second set except the reference second information may be indicated with respect to/based on the reference second information as discussed below.

In some embodiments, the second set of second information may be indicated by: a set of FD vectors corresponding to the second set of second information, and an absolute time value (also referred to as the first time information in the following) corresponding to the reference second information or corresponding to one of the set of FD vectors which is indicated as reference second information. In this example embodiment, the other second information may be derived from the set of FD vectors and the absolute time value.

Alternatively, in some embodiments, one of the second information comprised in the second set may be indicated as reference second information and may be indicated by an absolute time value (also referred to as the first time information in the following). Further, each of other second information in the second set may be indicated by a differential time value (also referred to as the third time information in the following) between a timing of the other second information and the absolute time value corresponding to the reference second information.

In some embodiments, compared with an absolute time value, a differential time value may be smaller. In view of this, the quantization used for indicating the differential time value may be different from the quantization used for indicating the absolute time value.

In some embodiments, the differential time value may be indicated based on a quantization associated with a size of frequency band for the at least one measurement report. Alternatively, or in addition, in some embodiments, the differential time value may be indicated based on a quantization associated with a size of bandwidth part (BWP) for the at least one measurement report. Alternatively, or in addition, in some embodiments, the differential time value may be indicated based on a quantization associated with a size of sub-carrier space (SCS) for the at least one measurement report.

In some embodiments, one second information in the second set may be associated with a subset of first information in the first set or associated with an angle. In some embodiments, the angle may be based on a first coordinate system corresponding to the second device. In some embodiments, the subset of first information in the first set may be a subset of first vectors, wherein the subset of first vectors may be selected from a group of first vectors. For example, each group may comprise a plurality of adjacent first vectors. For example, each group may comprise 2 or 4 or 6 or 8 or 16 adjacent first vectors.

In some embodiments, one first vector may be a vector with a first oversampling factor or with a first length. In some embodiments, the first oversampling factor may be 4 or 2 or 8 or 16. In some embodiments, the first length may be based on the number of antenna ports of the RS. In some embodiments, the first length may be 16 or 32 or N₁*N₂.

In some embodiments, there may be a parameter “N₁”, and “N₁” may represent a number of ports of the RS in a first dimension. For example, “N₁” may be at least one of {1, 2, 4, 8, 16, 32}. In some embodiments, there may be a parameter “N₂”, and “N₂” may represent a number of ports of the RS in a second dimension. For example, “N₂” may be at least one of {1, 2, 4, 8, 16, 32}. In some embodiments, the number of antenna ports of the RS may be 2*N₁*N₂.

For a better understanding, some example embodiments about how to indicate the second information are described as below.

In some embodiments, the second information (i.e., one second information item) may comprise or may be a second vector with a second length (or a second oversampling factor). Alternatively, in some embodiment, the second information, may comprise or may be an absolute time value (such as, a delay. For example, a value of first time information), where the absolute time value may be based on based on a first quantization. In some embodiments, the second oversampling factor may be 4 or 2 or 8 or 16. In some embodiments, the second length may be based on number of subbands or number of physical resource blocks for the RS or for the at least one measurement report. In some embodiments, the second length may be a positive integer. For example, the second length is larger than 1 (or no less than 52) and less than 275.

In some embodiments, there may be a first value of first time information (e.g., absolute time information) corresponding to the reference second information (For example, the reference second information may be represented as F_ref). Further, the first time information is based on a granularity of ‘ns’, ‘ms’, ‘s’ or ‘m’, where ‘m’ may be converted into ns/ms/s based on ‘m/c’, wherein c may be the speed of light). Further, there may be a value of third time information (e.g., differential time information) corresponding to other second information in the second set excluding the reference second information. In some embodiment, the third time information may be based on a third quantization. In some embodiments, the third time information or the third quantization may be related to the size of band for measurement report or size of BWP and/or SCS. In some embodiments, the speed of light c may be 299792458 m/s or 3*10⁸ m/s.

Additionally, in some embodiments, the at least one measurement report may further comprise an indication that indicates the reference second information i.e., F_ref.

In some embodiments, one cluster or one second information or one delay or one path may comprise or may be associated with a set of rays. In this event, the second information may be associated with the set of rays. In some embodiments, a value of second time information based on a second quantization may correspond to one ray. For example, the second quantization may be smaller than the first quantization.

In some embodiments, a value of one second time information corresponding to a ray (for example, the second time information may be a value of time delay corresponding to the ray) may be a differential value based on the value of first time information (for example, the first time information may be an absolute time of the reference second information) and/or third time information corresponding to the other second information in the second set except the reference second information.

In some embodiments, the (maximum) number of rays comprised in the set of rays corresponding to or associated with one second information may be Y, where Y may be positive integer. For example, 1<=Y<=4. For another example, 1<=Y<=8. In some embodiments, there may be up to X second information, wherein each one of X second information may correspond to or may be associated with a set of rays, where X may be positive integer. In some embodiments, X may be no larger than M. In some embodiments, M may be a positive integer. For example, 1<=M<=8. For another example, 1<=M<=4. In some embodiments, 1<=X<=4. In some embodiments, 1<=X<=min(M, 4). In some embodiments, 1<=X<=min(M, 2). In some embodiments, the X second information may be the ones with X lowest values of first time information and/or second time information and/or third time information. In some embodiments, the X second information may be the ones with X lowest values of time delay.

In some embodiments, if the number of rays comprised in the set of rays are larger, the X second information may be the ones with X lowest values of time information.

Additionally, in some embodiments, the at least one measurement report may also comprise indication of the number of rays associated with one second information (for example, the number of reported rays associated with the one second information in the measurement report, e.g., which may be up to Y).

In some embodiments, the measurement report may also comprise a bitmap for indicating the non-zero coefficients. In some embodiments, the bitmap may indicate the number of the non-zero coefficients and/or the index(es) of the first information corresponding to the non-zero coefficients and/or the index(es) of the second information corresponding to the non-zero coefficients. For example, the non-zero coefficient may be amplitude coefficient and/or phase coefficient.

In some embodiments, the size of bitmap may be based on the number of first information comprised in the first set (e.g., the number of first vectors in the set of first vectors), and/or the number of second information comprised in the second set (e.g., the number of second vectors in the set of second vectors by excluding the number of rays). In some embodiments, the size of bitmap may be 2L*M. In some embodiments, L may be positive integer. For example, 1<=L<=16. In some embodiments, M may be positive integer. For example, 1<=M<=18.

In some embodiments, the at least one measurement report may comprise a first subset of information (or a first subset of measurement or a first subset of measurement report) and a second subset of information (or a second subset of measurement or a second subset of measurement report). In some embodiments, the at least one measurement report may comprise a first measurement report and a second measurement report. In some embodiments, the first subset of information (or the first subset of measurement or the first subset of measurement report or the first measurement report) in the at least one measurement report may be composed for a first usage. For example, the first usage may be sensing. In some embodiments, the second subset of information (or the second subset of measurement or the second subset of measurement report or the second measurement report) in the at least one measurement report may be composed for a second usage. For example, the second usage may be communication and/or for calculation/report of precoding and/or for calculation/report of CQI or PMI or CSI. In some embodiments, CQI or CSI or PMI may be calculated/reported based on the second subset of information (or the second subset of measurement or the second subset of measurement report or the second measurement report).

In some embodiments, for different layers, there may be different subsets of information (or different subsets of measurement or different subsets of measurement report or different measurement report) applied for calculation/report of precoding and/or CQI and/or PMI and/or CSI.

In some embodiments, the first subset of information (or the first subset of measurement or the first subset of measurement report or the first measurement report) may be partially overlapped with second subset of information (or the second subset of measurement or the second subset of measurement report or the second measurement report). In some embodiments, the first subset of information (or the first subset of measurement or the first subset of measurement report or the first measurement report) may be a subset of the second subset of information (or the second subset of measurement or the second subset of measurement report or the second measurement report). In some embodiments, the second subset of information (or the second subset of measurement or the second subset of measurement report or the second measurement report) may be a subset of the first subset of information (or the first subset of measurement or the first subset of measurement report or the first measurement report).

In some embodiments, the at least one measurement report may also comprise indication of whether the first subset of information (or the first subset of measurement or the first subset of measurement report or the first measurement report) is included in second subset of information (or the second subset of measurement or the second subset of measurement report or the second measurement report). In some embodiments, the at least one measurement report may also comprise indication of whether the first subset of information (or the first subset of measurement or the first subset of measurement report or the first measurement report) is applied for calculation/report of precoding and/or CQI and/or CSI and/or PMI. In some embodiments, the second subset of information (or the second subset of measurement or the second subset of measurement report or the second measurement report) may also comprise indication of number of layers.

As for communication, considering overhead/complexity (e.g., subband size or PRG), there is no need of finer resolution for delay/path, and as for sensing, finer resolution may be needed, while there may be only a subset of delays/clusters that has recognizable rays. In view of this, there may be associations among the first information, the second information, the amplitude coefficients, the phase coefficients and the timing information for a set of rays. Some example embodiments are discussed as below.

In some embodiments, the second information may be associated with a subset of the first set of first information. In some embodiments, the first information comprised in the subset of the first set of first information may be adjacent vectors.

In one example embodiment, the second information may be associated with an angle, where the angle may be based on a first coordinate system corresponding to the second device 120. In another example, the second information may be associated with a subset of first vectors, where the subset of first vectors may be selected from a group of first vectors (For example, each group may comprise a plurality of adjacent first vectors). Additionally, in some embodiments, one first vector may be a vector with the first oversampling factor or with the first length.

For a better understanding, reference is now made to FIG. 1A, each beam 140/160 may correspond to respective first information (such as, a first vector). Beams 140-1 to 140-3 may correspond to first vectors of V1, V2 and V3 (which may be called as a subset of first vectors #1) and/or angle #1. Similarly, beams 160-1 to 160-3 may correspond to first vectors of V4, V5 and V6 (which may be called as a subset of first vectors #2) and/or angle #2. As one example correspondence, second information #1 may correspond to the subset of first vectors #1 and/or angle #1, while the second information #2 may correspond to the subset of first vectors #2 and/or angle #2.

In some embodiments, one second information (e.g., represented as F1) may be associated with a subset of first vectors (or a subset of first information), and/or a subset of amplitude coefficients and/or a subset of phase coefficients. In some embodiments, the second information or the subset of first vectors (or the subset of first information) may be associated with a set of rays. In some embodiments, a value of second time information based on the second quantization may correspond to one ray in the set of rays.

Alternatively, or in addition, in some embodiments, the second information may be associated with a subset of the third set of amplitude coefficients. Alternatively, or in addition, in some embodiments, the second information may be associated with a subset of the fourth set of phase coefficients.

Alternatively, or in addition, in some embodiments, the second information may be associated with a set of rays, each ray comprised in the set of rays may be associated with at least one of the following: an amplitude coefficient, a phase coefficient, or a time value. In some embodiments, the time value may be indicated by one of the following: a differential time value between the time value corresponding to the ray and a time value corresponding to the second information with which the set of rays associated with, or a differential time value between the time value corresponding to the ray and a time value corresponding to reference second information.

In some embodiments, a value of second time information of a ray may be based on the second quantization. Additionally, in some embodiments, there may be one phase coefficient and/or one amplitude coefficient corresponding to one ray in the set of rays.

In some embodiments, the set of rays may be associated with the same subset of first vectors and/or subset of amplitude coefficients and/or subset of phase coefficients.

In some embodiments, a precoding matrix and/or CQI may be based on the subset of first vectors (or the subset of first information), the subset of amplitude coefficients, the subset of phase coefficients and the second information. In some embodiments, the precoding matrix and/or CQI may not be based on the second time information and/or the set of rays and/or the phase coefficients corresponding to the set of rays and/or the amplitude coefficients corresponding to the set of rays.

In some embodiments, one first information may be associated with a subset of second vectors (or a subset of second information), and/or a subset of amplitude coefficients and/or a subset of phase coefficients. In some embodiments, each one of the subset of second information or each one of the subset of second vectors or the first information may be associated with a set of rays. In some embodiments, a value of second time information based on the second quantization may correspond to one ray in the set of rays.

In some embodiments, the first information may be associated with a subset of the third set of amplitude coefficients. Alternatively, or in addition, in some embodiments, the first information may be associated with a subset of the fourth set of phase coefficients.

Alternatively, or in addition, in some embodiments, the first information may be associated with a set of rays, each ray comprised in the set of rays may be associated with at least one of the following: an amplitude coefficient, a phase coefficient, or a time value.

In some embodiments, a precoding matrix and/or CQI may be based on the subset of second vectors (or the subset of the second information), the subset of amplitude coefficients, the subset of phase coefficients and the first information. In some embodiments, the precoding matrix and/or CQI may not be based on the second time information and/or the set of rays and/or the phase coefficients corresponding to the set of rays and/or the amplitude coefficients corresponding to the set of rays.

In some embodiments, the measurement for the set of rays may be based on an RS (or a port of an RS) with a first size of bands/resource blocks (RBs)/subbands. For example, the first size may be larger than a first threshold. In some embodiments, the first threshold may be a positive integer. For example, the first threshold may be larger than 20 and no less than 275. For example, the first threshold may be 52 RBs.

In some embodiments, in case of the measurement band size is smaller than the first threshold, there may be no set of rays reporting in the at least one measurement report.

In some embodiments, the at least one measurement report may further indicate at least one of the following: the number second information that is associated with a set of rays, the number of sets of rays or the number rays comprised in the set of rays.

Additionally, in some embodiments, the maximum number of rays comprised in the set of rays may be smaller than or equal to a threshold number. For example, the threshold number may be 2 or 3 or 4 or 5 or 6 or 7 or 8 or 9 or 10 or 11 or 12 or 13 or 14 or 15.

In some embodiments, the second time information corresponding to the one second information (e.g., one delay or one path) or corresponding to one ray may be within a range. In some embodiments, the range may be a threshold based on SCS or a ratio of cyclic prefix (CP) length. For example, the range may be A*CP, A may be at least one of ½, ⅓, ¼, ⅕, ⅙, ⅛.

In some embodiments, in case of channel model for sensing target, two line-of-sight (LOS) paths may be modeled, the LOS probability may be product of two LOS probability of the two paths.

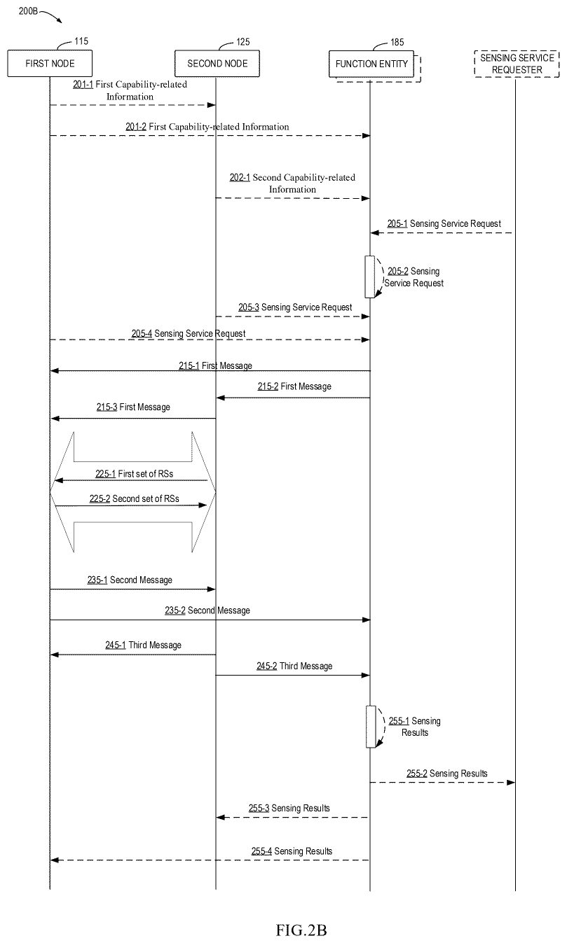

For a better understanding, reference is now made to FIG. 3A and FIG. 3B, which illustrates an example communication scenario 300A and example second information 300B. In FIGS. 3A and 3B, the second information 310 is associated with ray 311 and ray 312. In FIG. 3B, the second time information 350 corresponds to ray 311, while the second time information 355 corresponds to ray 312.

Reference is now made to FIG. 3C, which illustrates an example measurement report 300C. In FIG. 3C, the second time information is represented as a differential value based on the value of first time information and/or second time information corresponding to the second information.

In some embodiments, the second time information may be a differential value based on the value of first time information corresponding to second information F_ref, and the second information F1 may be based on the second time information of at least one rays corresponding to the second information F1. For example, the second information F1 may be rounding off values of the at least one rays based on the third quantization. In this case, there is no need of the second information reporting in the measurement report.

In some embodiments, one second information may be associated with a set of rays.

In some embodiments, the set of rays may comprise a first subset of rays and a second subset of rays.

In some embodiments, the set of rays may comprise a first ray and a second ray.

In some embodiments, the set of rays associated with the one second information may be associated with more than one subset of first vectors (or more than one subset of first information).

In some embodiments, the set of rays associated with the one second information may be associated with a first subset of first vectors (or a first subset of first information) and a second subset of first vectors (or a second subset of first information).

In some embodiments, the first subset of rays or the first ray may be associated with the first subset of first vectors (or the first subset of first information).

In some embodiments, the second subset of rays or the second ray may be associated with the second subset of first vectors (or the second subset of first information).

In some embodiments, the first subset of rays and the second subset of rays in the set of rays may be indexed or distinguished based on second time information and/or first subset of first vectors (or the first subset of first information) and second subset of first vectors (or the second subset of first information).

In some embodiments, the first ray and the second ray in the set of rays may be indexed or distinguished based on second time information and/or first subset of first vectors (or the first subset of first information) and second subset of first vectors (or the second subset of first information).

In some embodiments, the first subset of first vectors may be from a first plurality of adjacent first vectors.

In some embodiments, the second subset of first vectors may be from a second plurality of adjacent first vectors.

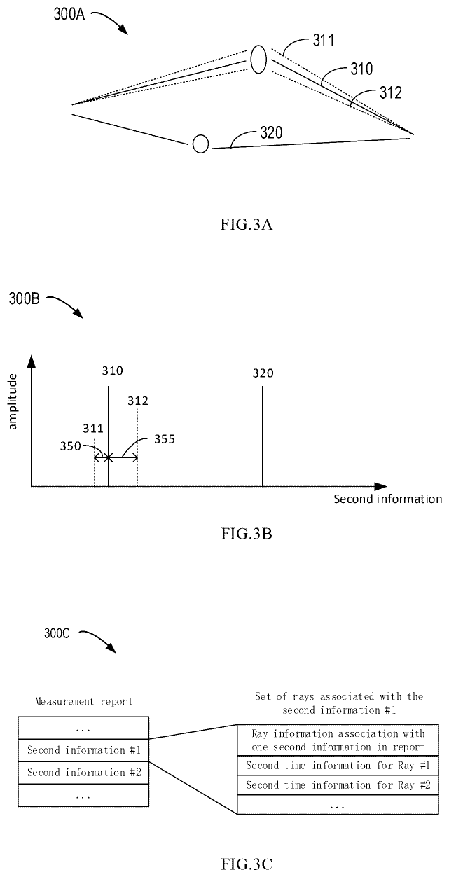

Reference is now made to FIG. 4A and FIG. 4B, which illustrates an example communication scenario 400A and an example measurement report 400C, respectively.

In FIGS. 4A and 4B, the second time information 450 corresponding to ray 410, the second time information 460 corresponding to ray 420, while the second time information 450 and 460 are differential values based on the F_ref.

In some embodiments, different rays comprised in the set of rays may be associated with different first information or different subsets of first information.

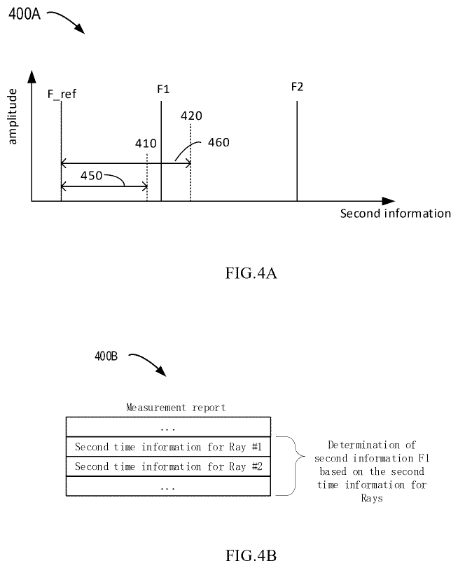

For a better understanding, reference is now made to FIG. 5A and FIG. 5B, which illustrates example communication scenario 500A and example second information 500B. In FIGS. 5A and 5B, ray 510 and ray 520 is associated with same second information while associated with different first information (such as, with different subsets of first vectors). In this even, in addition the second timing information 550 of ray 510 and the second timing information 560 of ray 520, the respective first information corresponding to rays 510 and 520 is needed. In other words, each ray may be indexed based on respective second time information and/or respective first information (such as, respective subsets of first vectors).

As discussed above, in some embodiments, the at least one measurements report may be associated with at least two different functionalities or usages. In order to better support the at least two different functionalities or usages, the at least one measurement report may indicate the first subset of information that is associated with a first functionality or first usage, and may indicate the second subset of information that is associated with a second functionality or second usage different from the first functionality or first usage.

In the following, more details about how to indicate the first and second subsets of information are discussed. In summary, the first subset of information and the second subset of information are associated with each other.

In some embodiments, the first subset of information and the second subset of information are at least partially overlapped. Alternatively, in some embodiments, the first subset of information is a subset of the second subset of information. Alternatively, in some embodiments, the second subset of information is a subset of the first subset of information.

Additionally, in some embodiments, the at least one measurement report may also comprise whether first subset of information is included in second subset or applied for calculation/report of precoding and/or CSI and/or CQI and/or PMI.

In some embodiments, a first subset of information in the at least one measurement report may be composed for a first functionality/usage (e.g., sensing), and a second subset of information in the at least one measurement report may be composed for a second functionality/usage (e.g., for a calculation/report of precoding or CQI or PMI or CSI, i.e., for communication). As a result, the CQI may be calculated based on the second subset of information. Further, in some embodiments, for different layers, different subsets of information may be applied for the calculation/report of precoding or CQI or CSI or PMI. Additionally, in some embodiments, the second subset may also comprise number of layers, and the number of layers also may be comprised in the at least one measurement report.

In some embodiments, the first measurement report may indicate a first subset of information and the second measurement report may indicate a second subset of information.

Alternatively, in some embodiments, the first measurement report may be used for the first functionality, and the second measurement report may be used the second functionality.

Alternatively, in some embodiments, the first measurement report may comprise a first portion of measurement results and the second measurement report may comprise a second portion of the measurement results.

In some embodiments, the first measurement report may comprise at least one of the following: a set of first information, a set of second information, or at least one set of ray information associated with respective second information comprised in the set of second information, and the second measurement report may comprise at least one of the following: a selection of the first information comprised in the set of first information, or a selection of the second information comprised in the set of second information.

In some embodiments, the at least one measurement report may comprise a first measurement report and/or a second measurement report, and at least one information/indication in the second measurement report may be associated with or may be based on or may depend on the at least one information/indication in the first measurement report.

In some embodiments, the payload for the second measurement report may be based on the at least one information/indication in the first measurement report. In some embodiments, the first subset of information may be comprised in the first measurement report. In some embodiments, the second subset of information may be comprised in the second measurement report.

In some embodiments, the first measurement report may be a report for the first functionality or first usage (for example, sensing).

In some embodiments, the second measurement report may be a report for the second functionality or second usage (For example, for calculation/report of CSI/PMI/CQI or for communication or for CSI/PMI/CQI report).

In some embodiments, the first measurement report may be a latest report prior to the second measurement report.

In some embodiments, the first measurement report may be a first part of the at least one measurement report and the second measurement report may be a second part of the at least one measurement report.

In some embodiments, the first measurement report may comprise at least one second information (e.g., a set of delays/paths, each second information may be a time information (for example, the time information may be at least one of the first time information, the second time information and the third time information) and/or at least one second time information for a set of rays associated with one of the at least one second information.

In some embodiments, the first measurement report may also comprise: at least one first information, a set of amplitude coefficients wherein each amplitude coefficient may correspond to one second information or one ray.

In some embodiments, the second measurement report may comprise an indication of selection of the at least one second information in the first measurement report and/or an indication of selection of the at least one first information in the first measurement report.

In some embodiments, one second information in the first measurement report may be converted into a second vector.

In some embodiments, a second vector with a third length or with a third oversampling factor.

In some embodiments, the third length may be smaller than the second length. In some embodiments, the third oversampling factor may be smaller than the second oversampling factor.

In some embodiments, the third length may be a positive integer. For example, the third length may be no less than 1 and no larger than 18.

In some embodiments, the indication of selection of the at least one second information may be based on a bitmap with size S_f. In some embodiments, S_f may be a positive integer. For example, S_f may be no less than 1 and no larger than 18. In some embodiments, S_f may be the (maximum) number of second information and/or (maximum) number of rays in the first measurement report.

In some embodiments, the indication of selection of the at least one first information may be based on a bitmap with size S_s. In some embodiments, S_s may be a positive integer. For example, S_s may be no less than 1 and no larger than 8. In some embodiments, S_s may be the (maximum) number of first information in the first measurement report.

In some embodiments, the second measurement report may also comprise at least one of: at least one first information, a set of amplitude coefficients corresponding to selected at least one second information and/or selected at least one first information and a set of phase coefficients corresponding to selected at least one second information and/or selected at least one first information.

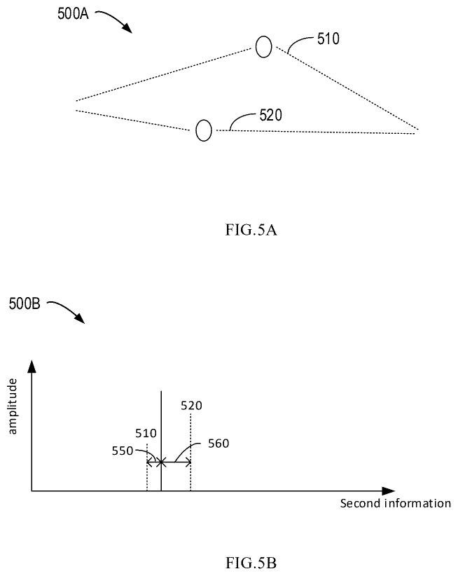

For a better understanding, reference is now made to FIG. 6, which illustrates an example of second information 600. In FIG. 6, the first measurement report may comprise ray 610, ray 620, second information 630 and second information 640, while the second measurement report may comprise second information 650 (For example, the second information 650 may correspond to or may be associated with ray 610 and 620) and the second information 660 (For example, the second information 660 and the second information 630 may be same or may correspond to a same value of time information or may correspond to a same second vector). Alternatively, the first measurement report may comprise ray 615, ray 625, second information 635 and second information 645, while the second measurement report may comprise second information 655 (For example, the second information 655 may correspond to or may be associated with ray 615 and 625) and the second information 665 (For example, the second information 665 and the second information 635 may be same or may correspond to a same value of time information or may correspond to a same second vector).

In some embodiments, the first device may be configured to determine/report at least one value of second time information and/or at least one amplitude coefficient for at least one ray based on a second configuration, wherein the second configuration may be indication of a second information and/or indication of at least one first vectors or at least one first information (e.g., the at least one first vector or the at least one first information may be associated with the second information).

In some embodiments, the first device may be determine/report at least one value of second time information and/or at least one amplitude coefficient for at least one ray based on a second configuration in the second measurement report.

In some embodiments, the second measurement report may also comprise indication of a number of the at least one ray.

In some embodiments, the number of the at least one ray may be differential value based on the number of rays in a first measurement report. For example, the differential value may be at least one of {−4,−3,−2,−1, 0, +1, +2, +3, +4} or {−2,−1, 0, +1} or {−1, 0, +1, +2}.

In some embodiments, the second measurement report may also comprise a bitmap to indication/selection of at least one ray in a first measurement report. In some embodiments, value 1 (or value 0) of one bit in the bitmap may indicate the corresponding ray is present in the second measurement report, and value 0 (or value 1) of one bit in the bitmap may indicate the corresponding ray is absent in the second measurement report.

In some embodiments, the second measurement report may also comprise indication of additional number of rays in the second measurement report. In some embodiments, the total number of the at least one ray in the second measurement report may be based on the bitmap (or the number of bits with value 1 in the bitmap) and the additional number of rays. In some embodiments, the value of the indication of additional number of rays may be at least one of {0,1,2,3,4,5,6,7}.

In some embodiments, the second measurement report may also comprise indication of the time information (e.g., at least one of the first time information, the second time information and the third time information) for the additional number of rays.

In some embodiments, the second time information corresponding to one ray in the second measurement report may be differential value based on time information corresponding to the ray in the first measurement report.

In some embodiments, the amplitude coefficient corresponding to one ray in a second measurement report may be differential value based on amplitude coefficient corresponding to the ray in the first measurement report.

In some embodiments, if one codepoint in the differential value may be <X, it may indicate the ray is absent in the second measurement report.

In some embodiments, the second device 120 may indicate the first device 110 to report measurements results associated with specific first information or second information. Still refer to FIG. 2A, the second device 120 may transmit 220 second configuration information indicating at least one first information and/or at least one second information to the first device 110. Based on the second configuration, the first device 110 may transmit a measurement report comprising measurement results about at least one ray or at least one newly-detected ray associated with the indicated first information and/or second information.

In some embodiments, the first device 110 may be configured to determine/report at least one value of second time information and/or at least one amplitude coefficient for at least one ray based on the second configuration, wherein the second configuration may be indication of the second information and/or indication of at least one first vectors (e.g., the at least one first vectors may be associated with the second information).

In some embodiments, the second report measurement may also comprise a number of the at least one ray.

In some embodiments, the number of the at least one ray may be differential value based on the number of rays in a first measurement report, e.g., the differential value may be {−1, 0, +1, +2}.

In some embodiments, the second measurement report may also comprise a bitmap to indication/selection of at least one ray in a first measurement report. Specifically, the bit value ‘1’ may indicate the ray present, and bit value ‘0’ may indicate the ray absent.

In some embodiments, the second measurement report may also comprise an additional number of rays (such as, the newly-detected ray), and the number of the at least one ray in the second measurement report may be based on the bitmap and the additional number of rays.

In addition, the second measurement report may also comprise the time information for the additional number of rays, wherein the second time information corresponding to one ray in the second measurement report may be differential value based on time information corresponding to the ray in the first measurement report.

In some embodiments, the amplitude coefficient corresponding to one ray in a second measurement report may be differential value based on amplitude coefficient corresponding to the ray in a first measurement report, for example, the codepoint in the differential value may be <X, which may indicate the ray is absent.

In some embodiments, the first device may be configured/indicated with a third configuration, wherein the third configuration may indicate at least one first information and/or at least one second information.

In some embodiments, the at least one first information and/or at least one second information indicated/configured in the third configuration and/or at least one amplitude coefficient corresponding to the at least one first information and/or at least one amplitude coefficient corresponding to the at least one second information and/or at least one phase coefficient corresponding to the at least one first information and/or at least one phase coefficient corresponding to the at least one second information may not be applied to second functionality or second usage (e.g. calculation/report of PMI/CSI/CQI).

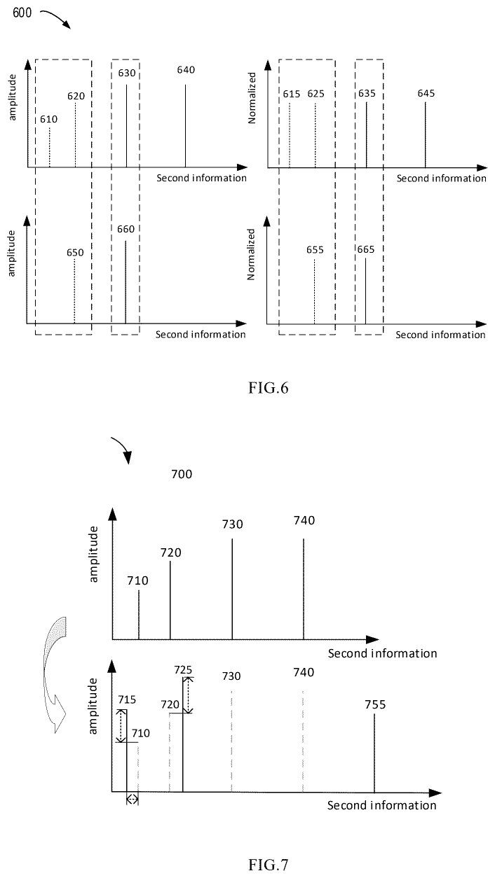

For a better understanding, reference is now made to FIG. 7, which illustrates an example of second information 700. In FIG. 1A, the first measurement report may comprise ray 710, ray 720, second information 730 and second information 740, while the second measurement report may comprise ray 715 (an update of ray 710), ray 725 (an update of ray 720). Further, the second information 730 and 740 are not selected and thus will not preset in the second measurement report. The second measurement report also may comprise the second information 755 is an additional (which is newly-detected), where the second information 755 may be associated with a set of first vectors different from that associated with the second information 740.

In some embodiments, the at least one measurement report may comprise a first measurement report and/or a second measurement report, and the information comprised in the second measurement report may be associated with the information comprised in the first measurement report.

Additionally, in some embodiments, the payload for the second measurement report may be based on the information in the first measurement report. In one example embodiment, the first subset of information may be comprised in the first measurement report, the second subset of information may be comprised in the second measurement report. In another example embodiment, the first measurement report may be a measurement report for sensing and the second measurement report may be a report for CSI/PMI/CQI.

In a further example embodiment, the first measurement report may be a first part of a measurement report and the second measurement report may be a second part of the measurement report.

In a further example embodiment, the first measurement report may be a latest report prior to the second measurement report.

In some embodiments, the first measurement report may comprise a second set of second information (e.g., a set of delays, each second information may be a time information, for example, at least one of first/second/third time information)) and/or at least one second time information for a set of rays associated with one second information.

The first measurement report may also comprise: at least one first information, a set of amplitude coefficients wherein each amplitude coefficient may correspond to one second information or one ray.

The second measurement report may comprise an indication of selection of the at least one second information in the first measurement report and/or an indication of selection of the at least one first information in the first measurement report. Additionally, the second information in the first measurement report (such as, a time information) may be converted into a second vector (such as, a FD vector). In some embodiments, the second vector may have a third length or have a third oversampling factor, wherein the third length or the third oversampling factor may be smaller than the second length or second oversampling factor.

In some embodiments, the indication of selection may be based on a bitmap with size S_f, wherein S_f may be the number of delays and/or rays in the first measurement report.

Additionally, in addition the to the second information, the second measurement report may also comprise a set of first information, a set of amplitude/phase coefficients corresponding to selected second information and the set of first information.

In some embodiments, the second device 120 may analyze the measurement report(s), and may indicate the analysis results to the first device 110. In some embodiments, the second device 120 may transmit 240 third configuration information indicating at least one of: a set of first information or a set of second information unapplicable for a specific functionality (such, CSI/PMI/CQI calculation/report).

In some embodiments, the first configuration information may further indicate at least one first antenna port and at least one second antenna port. In this event, in order to support more than one functionality. The first and second antenna ports may be configured with different parameter(s). For example, the reference signal for the at least one measurement report may be configured with P ports, where P may be one of {1, 2, 4, 8, 12, 16, 24, 32, 64, 96, 128}.

In some embodiments, the at least one first antenna port may be configured with a first density in a frequency resource, and the at least one second antenna port may be configured with a second density in the frequency resource, the second density being different from the first density.

As one example embodiment, one of the P ports (e.g., a first port) may be configured with a first density which is same or larger than one (e.g., 3 or 6) in one PRB, and the other of the P ports may be configured with a second density which is same or smaller than one in one PRB.

Alternatively, or in addition, in some embodiments, the at least one first antenna port may be configured with a first size of transmission resource, and the at least one second antenna port may be configured with a second size of transmission resource different from the first size of transmission resource.

As one example embodiment, one of the P ports (e.g., the first port) may be configured with a first size of PRBs, and the other ports of the P ports may be configured with a second size of PRBs, wherein first size is larger than the second size. For example, the first size may be larger than a first threshold, e.g., 52.

Alternatively, or in addition, in some embodiments, the at least one first antenna port may be used for a first functionality, and the at least one second antenna port is used for a second functionality different from the first functionality.

As one example embodiment, the first port may be mainly applied for sensing measurement, and all the P ports may be applied for communication (such as, CSI measurement).

In some embodiments, the first device 110 may receive the RS for the at least one measurement report based on a same spatial Rx filter.

Further, a transmission priority of the measure report discussed herein may be defined. In some embodiments, the measurement report indicating the first subset of information (or the first measurement report) may have a higher or lower priority than the measurement report indicating the second subset of information (or the second measurement report).

Alternatively, or in addition, in some embodiments, the at least one measurement report discussed herein may have a higher or lower priority than the CSI report(s) carrying layer 1-Reference Signal Receiving Power (L1-RSRP) or layer 1-Signal to Interference plus Noise Ratio (L1-SINR).

Alternatively, or in addition, in some embodiments, the at least one measurement report discussed herein may have a higher or lower priority than the CSI report(s) not carrying L1-RSRP or L1-SINR.

Alternatively, or in addition, in some embodiments, the at least one measurement report discussed herein may have a higher or lower priority than all the other CSI report.

In addition to receiving measurement report from the first device 110, the second device 120 also may instruct the first device to transmit the RS, and senses the object by measuring the RS by itself. In this specific scenario, the first device 110 may be a customer premises equipment (CPE), a fixed wireless access (FWA) or a network device.

In some embodiments, the first device 110 may receive configuration information from the second device 120, wherein the configuration information may comprise at least one of: configuration of the first RS, trigger information of the first RS, a set of first information and a set of second information.

Based on the configuration information from the second device 120, the first device 110 may transmit a first RS (e.g., sensing RSs) to the second device 120, where the first RS may be applied for communication and/or sensing.

In some embodiments, the SD filter for the transmission of the first RS may be based on measurement of a second RS corresponding to the set of first information and/or the set of second information.

In the following, reference is made to FIG. 2B, which illustrates another signaling flow 200B of communication in accordance with some embodiments of the present disclosure. For the purposes of discussion, the signaling flow 200B will be discussed with reference to FIG. 1B, for example, by using the first node 115, the second node 125 and the function entity 185.

It is to be understood that the operations at the first node 115, the second node and the function entity 185 should be coordinated. In other words, the first node 115, the second node and the function entity 185 should have common understanding about configurations, parameters and so on. Such common understanding may be implemented by any suitable interactions among the first node 115, the second node 125 and the function entity 185 or all the first node 115, the second node and the function entity 185 applying the same rule/policy.

In the following, although some operations are described from a perspective of the first node 115/second node 125/the function entity 185, it is to be understood that the corresponding operations should be performed by the other devices. Merely for brevity, some of the same or similar contents are omitted here.

In some example embodiments, the first node 115 may be operated as a terminal device or a network device, the second node 125 may be c operated as a network device, and the function entity 185 may be operated as a function entity including at least one of an AMF, an ISMF, an SF or an LMF.

In some embodiments, the first node 115 may receive at least one first message for sensing (also referred to as first signaling). As illustrated in FIG. 2B, the first node 115 (such as, a network device) may receive 215-1 the at least one first message for sensing from the function entity 185 (such as, a 5GC function).

Alternatively, or in addition, the first node 115 (such as, a terminal device) may receive 215-3 the at least one first message for sensing from the second node 125 (such as, a network device).

Alternatively, or in addition, the second node 125 (such as, a network device) also may receive the at least one first message for sensing. As illustrated in FIG. 2B, the second node 125 may receive 215-2 the at least one first message for sensing from the function entity 185 (such as, a 5GC function).

In some embodiments, after communicating the at least one first message, a sensing measurement may be performed between the first node 115 and the second node 150.

In some embodiments, the first node 115 may receive 225-1 a first set of RSs from the second node 125, and may determine at least one second message by measuring the first set of RSs. As a result, the first node 115 may transmit 235-1 the at least one second message to the second node 125. Alternatively, or in addition, the first node 115 may transmit 235-2 the at least one second message to the function entity 185.

In some embodiment, the at least one first message for sensing may comprise at least one first configuration (as discussed with reference to FIG. 2A). In this event, the at least one second message may be generated/transmitted based on the first message.

In some embodiments, the at least one second message may indicate at least one of the following:
a set of first information (such as, the first vector) related to SD. For example, the set of first information may be used for transmitting the first set of RSs. For another example, the set of first information may be measured based on the first set of RSs,
a set of second information (such as, the second vector) related to FD or related to timing information of path,
a set of timing information for a set of rays associated with the second information in the set of second information,
a set of third information (such as, the third vector) related to SD. For example, the set of third information may be used for receiving the first set of RSs. For another example, the set of third information may be measured based on the first set of RSs,
a first set of non-zero coefficients corresponding to the set of first information, or
a second set of non-zero coefficients corresponding to the set of third information.

In some embodiments, the first information may be at least one of: an SD vector, a CSI-RS port, an AoD, a ZoD, a beam for transmission, an SD filter for transmission, or a first vector. That is, the first information may well identify the spatial information for transmitting the first set of RSs.

In some embodiments, the length of the first information may be based on the number of antenna ports of the second node 125 configured to the first set of RSs or the number of antenna ports of the second node 125 used for transmission.

In some embodiments, the non-zero coefficient may be amplitude coefficient and/or phase coefficient.

In some embodiments, the second information may be at least one of: an FD vector, a timing information for a path, a delay or a second vector. More details about the second information may refer to the discussions made about FIGS. 2A, 3A to 7.

In some embodiments, the second information may be indicated by below example information element.

| | |
|---|---|
| numberOfPaths | INTEGER (1..X2_1), |
| numberOfPathsWithRay | INTEGER (1..X2_2), |
| timingReferencePath | INTEGER(0..X2_3), |

timingQuantityForReferencePath (e.g. first quantization),

| | |
|---|---|
| additionalPathList | ::= SEQUENCE (SIZE(1..numberOfPaths-1 or X2_1 −1)) OF rela- |

tiveTimePath,
timingQuantityForAdditionalPath (e.g. second quantization),

| | |
|---|---|
| relativeTimePath | INTEGER(0..X2_4), |
| pathWithRayList | ::= SEQUENCE (SIZE(1..numberOfPathsWithRay −1 or X2_2 −1)) OF |

pathWithRay,

| | |
|---|---|
| pathWithRayList | ::= SEQUENCE { |
| numberOfRays | INTEGER(0..X2_5), |
| rayList | RayList, |

}

| | |
|---|---|
| RayList | ::= SEQUENCE (SIZE(1..numberOfRays −1 or X2_5 −1)) OF rayPerPath, |

timingQuantityForRay (e.g. third quantization),

| | |
|---|---|
| rayPerPath | INTEGER(0..X2_6). |

In some embodiments, X2_1 may be a positive integer. For example, 1<=X2 1<=20. In some embodiments, X2_2 may be a positive integer. For example, 1<=X2_2<=4.

In some embodiments, the third information may be at least one of: an SD vector, a CSI-RS port for reception, an azimuth angle of arrival (AoA), an angle of arrival (AoA), a zenith angle of arrival (ZoA), a beam for reception, an SD filter for reception. That is, the third information may well identify the spatial information for receiving the first set of RSs.

In some embodiments, the length of the third information (such as, the third vector) may be based on the number of antenna ports of the first node 115 configured to the first set of RSs or the number of antenna ports of the first node 115 for reception.

In some embodiments, the second node 125 may measure the RSs and obtain information used for sensing. Such procedure will be discussed as below.

In some embodiments, the at least one first message may indicate resources used for transmitting the second set of RSs. In some embodiments, the resources may time and/or frequency domain resources for the second set of RSs, e.g., subcarrier location and/or symbol index(es).

Alternatively, or in addition, in some embodiments, the at least one first message may indicate a set of transmission parameters used for transmitting the second set of RSs. In some embodiments, the transmission parameters include but are not limited to density, periodicity and offset.

Alternatively, or in addition, in some embodiments, the at least one first message may indicate a set of fourth information related to SD and used for transmitting the second set of RSs. In some embodiments, the fourth information may at least one of: an SD vector, a channel state information reference signal (CSI-RS) port, an azimuth angle of departure (AoD), an angle of departure (AoD), a zenith angle of departure (ZoD), a beam for transmission, an SD filter for transmission.

Alternatively, or in addition, in some embodiments, the at least one first message may indicate a set of non-zero coefficients (including the amplitude coefficients and/or the phase coefficients) for transmission of the second set of RSs.

Additionally, in some embodiments, the length of the fourth information may be based on the number of antenna ports of the first node 115 configured to the second set of RSs or the number of antenna ports of the first node 115 used for transmission.

Alternatively, or in addition, in some embodiments, the at least one first message may indicate at least one second information related to FD, related to timing information of path, at least one delay or at least one second vector. In some embodiments, the second information may be at least one of: an FD vector, or a timing information for a path.

With the above information, the second node 125 may instruct the first node 115 to transmit a second set of RSs. Then, as illustrated in FIG. 2B, the second node 125 may receive 225-2 the second set of RSs. By measuring the second set of RSs, the second node 125 may obtain at least one third message comprising information used for sensing.

In some embodiments, the second node 125 may transmit 245-1 the at least one third message comprising information used for sensing to the first node 115. Alternatively, or in addition, the second node 125 may transmit 245-2 the at least one third message comprising information used for sensing to the function entity 185.

In some embodiments, the at least one third message indicates a set of fifth information related to SD and used for receiving the second set of RSs.

In some embodiments, the fifth information (also may referred to as fifth vector) may be at least one of: an SD vector, one channel state information reference signal (CSI-RS) port for reception, an azimuth angle of arrival (AoA), an angle of arrival (AoA), a zenith angle of arrival (ZoA), a beam for reception, an SD filter for reception.

In some embodiments, the second set of RSs may be transmitted based on measurement of the first set of RSs. Specifically, in some embodiments, the second node 125 may transmit the first set of RSs to the first node 115, and the transmission of the second set of RSs may be based on the reception/measurement of the first set of RSs.

In some embodiments, the at least one second/third message may further indicate a first location information of the first node 115. In some embodiments, the first location information may comprise at least one of a first three-dimensional coordinate of the first node 115, a first horizontal direction information of an antenna panel of the first node 115 or a first vertical direction information of the antenna panel of the first node 115.

Alternatively, or in addition, in some embodiments, the at least one second/third message may further indicate a second location information of the second node 125. In some embodiments, the second location information may comprise at least one of a second three-dimensional coordinate of the first node 115, a second horizontal direction information of an antenna panel of the second node 125 or a second vertical direction information of the antenna panel of the second node 125.

In some embodiments, the first node 115 and the second node 125 may exchange the location information. In some embodiments, the first node 115 (or the second node 125) may deliver/transfer the first location information of the first node 115 (or the second location information of the second node 125) to the second node 125 (or the first node 115) and/or the function entity 185.

In some embodiments, the first and second location information may be mapped into a same coordinate system. In some embodiments, the first and second location information may be based on positioning.

In some embodiments, if the first and second location information belong to different coordinate systems, a transformation of coordinate system is needed.

In some embodiments, if the at least one first information and/or the at least one fourth information and/or the first location information are associated with the second node 125 or associated with a second coordinate system and if they are delivered to the first node 115 and/or the function entity 185, they may be converted into a first coordinate system (associated with the first node 115) or a third coordinate system (which may be configured to the first node 115 and the second node 125, e.g. from the function entity 185).

In some embodiments, if the at least one third information and/or the at least one fifth information are associated with the first node or associated with the first coordinate system and if they are delivered to the second node 125 and/or the function entity 185, they may be converted into the second coordinate system (associated with the second node) or the third coordinate system (which may be configured to the first node 115 and the second node 125, e.g. from the function entity 185).

As discussed above, after communicating the first message, the at least one second message comprising information used for sensing may be determined by the first node, and the at least one third message comprising information used for sensing may be determined by the second node. By communicating the at least one second message and the at least one third message among the first node, the second node and the function entity, the information used for sensing may be obtained by suitable network element(s).

In some embodiments, the information used for sensing comprised in the at least one second message may be the same with the information used for sensing comprised in the at least one third message.

Alternatively, in some embodiments, the information used for sensing comprised in the at least one second message may be partly overlapped with the information used for sensing comprised in the at least one third message. In other words, a part of the information used for sensing comprised in the at least one second message may be the same with a part of the information used for sensing comprised in the at least one third message.

Alternatively, in some embodiments, the information used for sensing comprised in the at least one second message may be a subset of the information used for sensing comprised in the at least one third message.

Alternatively, in some embodiments, the information used for sensing comprised in the at least one third message may be a subset of the information used for sensing comprised in the at least one second message.

In some embodiments, the information used for sensing comprised in the at least one second message may be different from the information used for sensing comprised in the at least one third message.

Optionally, the capability-related information may be exchanged among the first node 115, the second node 125 and the function entity 185. As illustrated in FIG. 2B, in some embodiments, the first node 115 may transmit 201-1 first capability-related information indicating whether a capability for the second message is supported by the first node 115 to the second node 125.

In some embodiments, prior to transmitting the first capability-related information, the first node 115 may receive a first request for the first capability-related information from the second node 125.

Alternatively, or in addition, the first node 115 may transmit 201-2 the first capability-related information indicating whether a capability for the second message is supported by the first node 115 to the function entity 185.

In some embodiments, the first capability-related information may further indicate whether the first node 115 supports ISAC, may further indicate whether the first node 115 supports generate/measure/transfer the second message. Alternatively, or in addition, the first capability-related information may further indicate whether the first node 115 supports generate/measure/transfer at least one measurement report which comprises a first measurement report and a second measurement report associated with the first measurement report, or supports generate/measure/transfer at least one measurement report used for at least two usages/functionalities and so on. In summary, the first capability-related information may indicate any suitable capability information of the first node 115.

In some embodiments, prior to transmitting the first capability-related information, the first node may receive a first request for the first capability-related information from the function entity 185.

Similar with the first node 115, in some embodiments, the second node 125 also may transmit 201-1 second capability-related information to the function entity 185, where the second capability-related information indicates whether a capability for the third message is supported by the second node 125.

It should be understood that the second capability-related information may indicate any suitable capability information of the second node 125. The present disclosure is not limited in this regard.

With the above procedure, the function entity 185 may receive at least one second message from the first node 115 and/or receive at least one third message from the second node 125. Further, in some embodiments, the function entity 185 may determine 255-1 sensing results based on the at least one second message and/or the at least one third message.

In some embodiments, in case that the function entity 185 comprises more than one 5GC function, the sensing results may be exchanged among the more than one 5GC function.

In some embodiments, the function entity 185 may comprise AMF and/or ISMF, and the ISMF may provide the sensing service response to the AMF and may include any needed measurement (e.g., success or failure indication and/or at least one measurement and/or first location information and/or second location information).

In some embodiments, the function entity 185 may comprise AMF and/or ISMF, and the ISMF may provide the sensing service response to the AMF and may include any needed measurement (e.g., success or failure indication).

In some embodiments, the function entity 185 may comprise AMF and/or ISMF, and the ISMF may deliver/transmit the measurement to an Application Function.

Alternatively, or in addition, in some embodiments, the function entity 185 may transmit 255-3 the sensing results to the second node 125, transmit 255-4 the sensing results to the first node 115, and/or transmit 255-4 the sensing results to the sensing service requester.

Optionally, the above procedure may be triggered by a sensing service request. In some embodiments, the function entity 185 may receive 205-1 the sensing service request from the sensing service requester.

Alternatively, or in addition, in case that the function entity 185 may comprise more than one 5GC function, the sensing service request may be triggered 205-2 by one of the 5GC function.

In some embodiments, one 5GC function of the function entity 185 may determine the need for some sensing service for at least one target (e.g., within a coverage area for the first node 115 and/or the second node 125).

In some embodiments, the function entity 185 may comprise AMF and/or ISMF, and the AMF may transfer the sensing service request to the ISMF.

Alternatively, or in addition, in some embodiments, the function entity 185 may receive 205-3 the sensing service request from the second node 125 and/or receive 205-4 the sensing service request from the first node 115.

In some embodiments, some entities (such as, the sensing service requester) in the 5GC may request some sensing service for at least one target to the serving first function.

In some embodiments, the first node 115 and/or second node 125 may request some sensing service for at least one target to the function entity.

In some embodiments, the sensing service request may comprise a request for sensing and/or a request for the measurement report.

In some embodiments, if the function entity 185 receives the sensing service request from the sensing service requester (such as, the 5GC entity), the function entity 185 may return a sensing service response (i.e., sensing results) to the 5GC entity. The sensing service response may comprise any needed results (e.g., success or failure indication and/or at least one measurement and/or first location information and/or second location information).

In some embodiments, if the sensing service request may be triggered 205-2 by one of the 5GC function, e.g., the function entity 185 comprises an AMF and/or ISMF, and the AMF may transfer the sensing service request to the ISMF. In this event, the function entity 185 may use the sensing service response to assist the service. In some embodiments, the serving first function comprised in the function entity 185 (such as, the AMF) may determine the need for some sensing service for at least one target (e.g., within a coverage area for the first and/or the second node).

In some embodiments, if the function entity 185 may receive 205-3 the sensing service request from the second node 125 and/or receive 205-4 the sensing service request from the first node 115, the function entity 185 may return a sensing service response to the first node 115 and/or the second node 125, and may include any needed sensing results (e.g., at least one measurement and/or first location information and/or second location information).

In some embodiments, the function entity 185 may enable the AMF to request the NG-RAN node to report the first node and/or second node's at least one measurement and/or first location information and/or second location information.

Alternatively, in some embodiments, the function entity 185 may enable the NG-RAN node to report the first node and/or second node's at least one measurement and/or first location information and/or second location information.

In some embodiments, the following procedures are used to report the measurement of the target: integrated sensing reporting control, integrated sensing report, integrated sensing reporting failure indication.

In some embodiments, the first node 115 may be in a connected mode or connected with second node 125 and/or the function entity.

### Example Methods

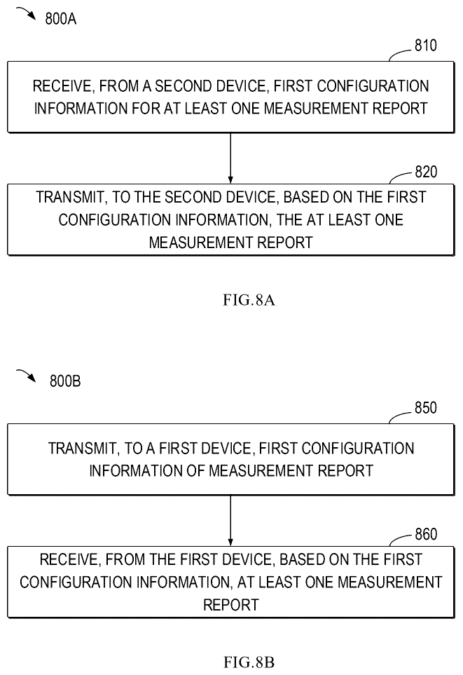

FIG. 8A illustrates a flowchart of a communication method 800A implemented at a first device in accordance with some embodiments of the present disclosure. For the purpose of discussion, the method 800A will be described from the perspective of the first device 110 in FIG. 1A.

At block 810, the first device receives, from a second device, first configuration information for at least one measurement report.

At block 820, the first device transmits, to the second device, based on the first configuration information, at least one measurement report indicating at least one of the following: a first set of first information related to spatial domain (SD), a second set of second information related to frequency domain (FD) or timing information for path, a third set of amplitude coefficients, a fourth set of phase coefficients, or a fifth set of timing information for a set of rays associated with one second information in the second set of second information. Further, the at least one measurement report comprises at least one of: a first subset of information and a second subset of information, wherein the first or the second subset of information is applied for a calculation/report of precoder or channel quality indicator (CQI) or PMI or CSI, or a first measurement report and a second measurement report associated with the first measurement report.

In some example embodiments, the first information may be at least one of: an SD vector, one channel state information reference signal (CSI-RS) port, an angle of departure, a zenith angle of departure (ZoD), an angle of a directional angle or a beam, and the second information may be at least one of: an FD vector, or a timing information for a path.

In some example embodiments, the first configuration information may indicate at least one of the following: the number of first information comprised in the first set, the number of second information comprised in the second set, the number of amplitude coefficients, or the number of phase coefficients.

In some example embodiments, each second information comprised in the second set may be indicated by an absolute time value, or one of the second information comprised in the second set is indicated as reference second information and indicated by an absolute time value, and each of other second information may be indicated by a differential time value between a time value of the other second information and the absolute time value.

In some example embodiments, the second set of second information may be indicated by: a set of FD vectors corresponding to the second set of second information, and an absolute time value corresponding to one of the set of FD vectors which is indicated as reference second information.

In some example embodiments, the at least one measurement report further may indicate the reference second information.

In some example embodiments, the differential time value may be indicated based on a quantization associated with at least one of the following: a size of frequency band for the at least one measurement report, a size of bandwidth part (BWP) for the at least one measurement report, or a size of sub-carrier space (SCS) for the at least one measurement report.

In some example embodiments, the at least one measurement report may be associated with at least two different functionalities and indicates: the first subset of information associated with a first functionality, and the second subset of information associated with a second functionality different from the first functionality.

In some example embodiments, the first subset of information and the second subset of information may be at least partially overlapped, the first subset of information may be a subset of the second subset of information, or the second subset of information may be a subset of the first subset of information.

In some example embodiments, the first measurement report may indicate a first subset of information associated with a first functionality and the second measurement report indicates a second subset of information associated a second functionality different from the first functionality.

In some example embodiments, the first measurement report may be used for the first functionality, and the second measurement report may be used for the second functionality.

In some example embodiments, the first measurement report may comprise a first portion of measurement results and the second measurement report may comprise a second portion of the measurement results.

In some example embodiments, the first measurement report may comprise at least one of the following: a set of first information, a set of second information, or at least one set of ray information associated with respective second information comprised in the set of second information, and the second measurement report may comprise at least one of the following: a selection of the first information comprised in the set of first information, or a selection of the second information comprised in the set of second information.

In some example embodiments, transmitting the at least one measurement report comprises: receiving, from the second device, second configuration information indicating at least one first information and/or at least one second information; and transmitting, to the second device, a measurement report comprising measurement results about the at least one ray or at least one newly-detected ray associated with the at least one first information and/or at least one second information.

In some example embodiments, the first device may receive, from the second device, third configuration information indicating at least one of: a set of first information or a set of second information unapplicable for a specific functionality.

In some example embodiments, the first configuration information may further indicate at least one first antenna port and at least one second antenna port, and wherein the at least one first antenna port is configured with a first density in a frequency resource, and the at least one second antenna port is configured with a second density in the frequency resource, the second density being different from the first density, the at least one first antenna port is configured with a first size of transmission resource, and the at least one second antenna port is configured with a second size of transmission resource different from the first size of transmission resource, or the at least one first antenna port is used for a first functionality, and the at least one second antenna port is used for a second functionality different from the first functionality.

In some example embodiments, the second information may be associated with at least one of the following: a subset of the first set of first information, wherein the first information comprised in the subset of the first set of first information is adjacent, a subset of the third set of amplitude coefficients, a subset of the fourth set of phase coefficients, or a set of rays, each ray comprised in the set of rays being associated with at least one of the following: an amplitude coefficient, a phase coefficient, or a time value, wherein the time value is indicated by one of the following: a differential time value between the time value corresponding to the ray and a time value corresponding to the second information with which the set of rays associated, or a differential time value between the time value corresponding to the ray and a time value corresponding to reference second information.

In some example embodiments, the at least one measurement report may further indicate at least one of the following: the number second information that is associated with a set of rays, or the number rays comprised in the set of rays.

In some example embodiments, different rays comprised in the set of rays may be associated with different first information or different subsets of first information.

In some example embodiments, the maximum number of rays comprised in the set of rays may be smaller than or equal to a threshold number.

In some example embodiments, the at least two different functionalities may comprise a first functionality of sensing and a second functionality of communication.

In some example embodiments, the first device may be a terminal device and the second device may be a network device.

FIG. 8B illustrates a flowchart of a communication method 800B implemented at a second device in accordance with some embodiments of the present disclosure. For the purpose of discussion, the method 800B will be described from the perspective of the second device 120 in FIG. 1A.

At block 850, the second device transmits, to a first device, first configuration information for at least one measurement report.

At block 860, the second device receives, from the first device, based on the first configuration information, at least one measurement report indicating at least one of the following: a first set of first information related to spatial domain (SD), a second set of second information related to frequency domain (FD) or timing information for path, a third set of amplitude coefficients, a fourth set of phase coefficients, or a fifth set of timing information for a set of rays associated with one second information in the second set of second information. Further, the at least one measurement report comprises at least one of: a first subset of information and a second subset of information, wherein the first or the second subset of information is applied for a calculation/report of precoder or channel quality indicator (CQI) or CSI or PMI, or a first measurement report and a second measurement report associated with the first measurement report.

In some example embodiments, the first information may be at least one of: an SD vector, one channel state information reference signal (CSI-RS) port, an angle of departure, a zenith angle of departure (ZoD), an angle of a directional angle or a beam, and the second information may be at least one of: an FD vector, or a timing information for a path.

In some example embodiments, the first configuration information may indicate at least one of the following: the number of first information comprised in the first set, the number of second information comprised in the second set, the number of amplitude coefficients, or the number of phase coefficients.

In some example embodiments, each second information comprised in the second set may be indicated by an absolute time value, or one of the second information comprised in the second set is indicated as reference second information and indicated by an absolute time value, and each of other second information may be indicated by a differential time value between a time value of the other second information and the absolute time value.

In some example embodiments, the second set of second information may be indicated by: a set of FD vectors corresponding to the second set of second information, and an absolute time value corresponding to one of the set of FD vectors which is indicated as reference second information.

In some example embodiments, the at least one measurement report further may indicate the reference second information.

In some example embodiments, the differential time value may be indicated based on a quantization associated with at least one of the following: a size of frequency band for the at least one measurement report, a size of bandwidth part (BWP) for the at least one measurement report, or a size of sub-carrier space (SCS) for the at least one measurement report.

In some example embodiments, the at least one measurement report may be associated with at least two different functionalities and indicates: the first subset of information associated with a first functionality, and the second subset of information associated with a second functionality different from the first functionality.

In some example embodiments, the first subset of information and the second subset of information may be at least partially overlapped, the first subset of information may be a subset of the second subset of information, or the second subset of information may be a subset of the first subset of information.

In some example embodiments, the first measurement report may indicate a first subset of information associated with a first functionality and the second measurement report indicates a second subset of information associated a second functionality different from the first functionality.

In some example embodiments, the first measurement report may be used for the first functionality, and the second measurement report may be used for the second functionality.

In some example embodiments, the first measurement report may comprise a first portion of measurement results and the second measurement report may comprise a second portion of the measurement results.

In some example embodiments, the first measurement report may comprise at least one of the following: a set of first information, a set of second information, or at least one set of ray information associated with respective second information comprised in the set of second information, and the second measurement report may comprise at least one of the following: a selection of the first information comprised in the set of first information, or a selection of the second information comprised in the set of second information.

In some example embodiments, transmitting the at least one measurement report may comprise: receiving, from the second device, second configuration information indicating at least one first information and/or at least one second information; and transmitting, to the second device, a measurement report comprising measurement results about the at least one ray or at least one newly-detected ray associated with the at least one first information and/or at least one second information.

In some example embodiments, the second device may transmit, to the first device, third configuration information indicating at least one of: a set of first information or a set of second information unapplicable for a specific functionality.

In some example embodiments, the first configuration information may further indicate at least one first antenna port and at least one second antenna port, and wherein the at least one first antenna port is configured with a first density in a frequency resource, and the at least one second antenna port is configured with a second density in the frequency resource, the second density being different from the first density, the at least one first antenna port is configured with a first size of transmission resource, and the at least one second antenna port is configured with a second size of transmission resource different from the first size of transmission resource, or the at least one first antenna port is used for a first functionality, and the at least one second antenna port is used for a second functionality different from the first functionality.

In some example embodiments, the second information may be associated with at least one of the following: a subset of the first set of first information, wherein the first information comprised in the subset of the first set of first information is adjacent, a subset of the third set of amplitude coefficients, a subset of the fourth set of phase coefficients, or a set of rays, each ray comprised in the set of rays being associated with at least one of the following: an amplitude coefficient, a phase coefficient, or a time value, wherein the time value is indicated by one of the following: a differential time value between the time value corresponding to the ray and a time value corresponding to the second information with which the set of rays associated, or a differential time value between the time value corresponding to the ray and a time value corresponding to reference second information.

In some example embodiments, the at least one measurement report may further indicate at least one of the following: the number second information that is associated with a set of rays, or the number rays comprised in the set of rays.

In some example embodiments, different rays comprised in the set of rays may be associated with different first information or different subsets of first information.

In some example embodiments, the maximum number of rays comprised in the set of rays may be smaller than or equal to a threshold number.

In some example embodiments, the at least two different functionalities may comprise a first functionality of sensing and a second functionality of communication.

In some example embodiments, the first device may be a terminal device and the second device may be a network device.

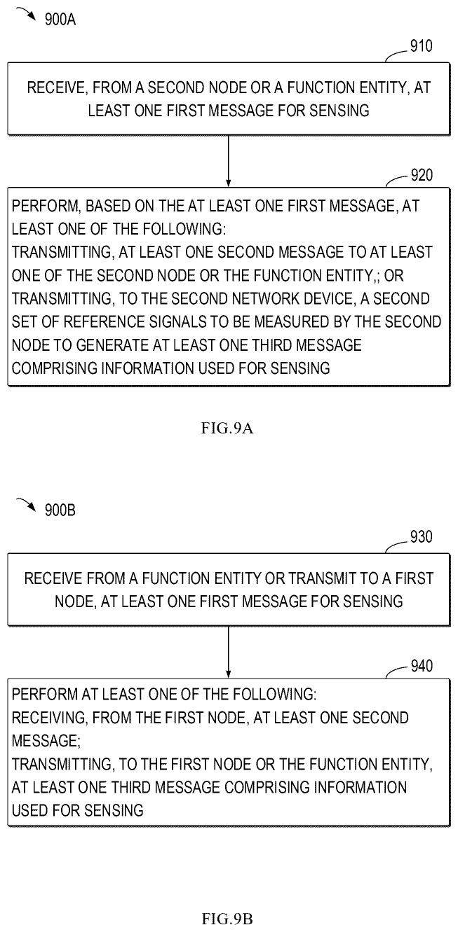

FIG. 9A illustrates a flowchart of a communication method 900A implemented at a first node in accordance with some embodiments of the present disclosure. For the purpose of discussion, the method 900A will be described from the perspective of the first node 115 in FIG. 1B.

At block 910, the first node may receive from a second node or a function entity, at least one first message for sensing.

At block 920, the first node may perform, based on the at least one first message, at least one of the following: transmitting, at least one second message to at least one of the second node or the function entity, the at least one second message comprising information used for sensing, the at least one second message being determined by the first node by measuring a first set of reference signals (RSs) transmitted by the second node; or transmitting, to the second node, a second set of RSs to be measured by the second node to generate at least one third message comprising information used for sensing.

In some example embodiments, the at least one second message may indicate at least one of the following: a set of first information related to spatial domain (SD) and used for transmitting the first set of RSs, a set of second information related to frequency domain (FD) or related to timing information of path, a set of timing information for a set of rays associated with the second information in the set of second information, a set of third information related to SD and used for receiving the first set of RSs, a first set of non-zero coefficients corresponding to the set of first information, or a second set of non-zero coefficients corresponding to the set of third information.

In some example embodiments, the first information may be at least one of: an SD vector, a channel state information reference signal (CSI-RS) port, an azimuth angle of departure (AoD), an angle of departure (AoD), a zenith angle of departure (ZoD), a beam for transmission, an SD filter for transmission, the second information may be at least one of: an FD vector, or a timing information for a path, and the third information may be at least one of: an SD vector, a CSI-RS port for reception, an azimuth angle of arrival (AoA), an angle of arrival (AoA), a zenith angle of arrival (ZoA), a beam for reception, an SD filter for reception.

In some example embodiments, the length of the first information may be based on the number of antenna ports of the second node configured to the first set of RSs or the number of antenna ports of the second node used for transmission, and wherein the length of the third information may be based on the number of antenna ports of the first node configured to the first set of RSs or the number of antenna ports of the first node for reception.

In some example embodiments, the at least one first message may indicate at least one of the following: resources used for transmitting the second set of RSs, a set of transmission parameters used for transmitting the second set of RSs, a set of fourth information related to SD and used for transmitting the second set of RSs, or at least one second information related to FD or related to timing information of path.

In some example embodiments, the fourth information may be at least one of: an SD vector, a channel state information reference signal (CSI-RS) port, an azimuth angle of departure (AoD), an angle of departure (AoD), a zenith angle of departure (ZoD), a beam for transmission, an SD filter for transmission, the second information may be at least one of: an FD vector, or a timing information for a path.

In some example embodiments, the length of the fourth information may be based on the number of antenna ports of the first node configured to the second set of RSs or the number of antenna ports of the first node used for transmission.

In some example embodiments, the at least one third message may indicate at least one of the following: a set of fifth information related to SD and used for receiving the second set of RSs.

In some example embodiments, the fifth information may be at least one of: an SD vector, one channel state information reference signal (CSI-RS) port for reception, an azimuth angle of arrival (AoA), an angle of arrival (AoA), a zenith angle of arrival (ZoA), a beam for reception, an SD filter for reception.

In some example embodiments, the second set of RSs may be transmitted based on measurement of the first set of RSs.

In some example embodiments, the at least one second message may further indicate at least one of the following: a first location information of the first node, or a second location information of the second node.

In some example embodiments, the first location information may comprise at least one of a first three-dimensional coordinate of the first node, a first horizontal direction information of an antenna panel of the first node or a first vertical direction information of the antenna panel of the first node; and the second location information comprises at least one of a second three-dimensional coordinate of the first node, a second horizontal direction information of an antenna panel of the second node or a second vertical direction information of the antenna panel of the second node.

In some example embodiments, the first and second location information may be mapped into a same coordinate system.

In some example embodiments, the first node may transmit to at least one of the second node or the function entity first capability-related information indicating whether a capability for the second message is supported by the first node.

In some example embodiments, prior to transmitting the first capability-related information, the first node may receive a first request for the first capability-related information from the second node or the function entity.

In some example embodiments, the first node may be a terminal device or a network device, the second node may be a network device, and the function entity may be at least one of an access and mobility management function (AMF), an integrated sensing management function (ISMF), a sensing function (SF) or a location management function (LMF).

FIG. 9B illustrates a flowchart of a communication method 900B implemented at a second node in accordance with some embodiments of the present disclosure. For the purpose of discussion, the method 900B will be described from the perspective of the second node 125 in FIG. 1B.

At block 930, the second node may receive from a function entity or transmit to a first node, at least one first message for sensing.

At block 940, the second node may perform at least one of the following: receiving, from the first node, at least one second message, the at least one second message comprising information used for sensing, the at least one second message being determined by the first node by measuring a first set of reference signals (RSs) transmitted by the second node; transmitting, to the first node or the function entity, at least one third message comprising information used for sensing, the at least one third message being determined by the second node by measuring a second set of RSs transmitted by the first node based on the at least one first message.

In some example embodiments, the at least one second message may indicate at least one of the following: a set of first information related to spatial domain (SD) and used for transmitting the first set of RSs, a set of second information related to frequency domain (FD) or related to timing information of path, a set of timing information for a set of rays associated with the second information in the set of second information, a set of third information related to SD and used for receiving the first set of RSs, a first set of non-zero coefficients corresponding to the set of first information, or a second set of non-zero coefficients corresponding to the set of third information.

In some example embodiments, the first information may be at least one of: an SD vector, a channel state information reference signal (CSI-RS) port, an azimuth angle of departure (AoD), an angle of departure (AoD), a zenith angle of departure (ZoD), a beam for transmission, an SD filter for transmission, the second information may be at least one of: an FD vector or a timing information for a path, and the third information may be at least one of: an SD vector, a CSI-RS port for reception, an azimuth angle of arrival (AoA), an angle of arrival (AoA), a zenith angle of arrival (ZoA), a beam for reception, an SD filter for reception.

In some example embodiments, the first information may be at least one of: an SD vector, a channel state information reference signal (CSI-RS) port, an azimuth angle of departure (AoD), an angle of departure (AoD), a zenith angle of departure (ZoD), a beam for transmission, an SD filter for transmission, the second information may be at least one of: an FD vector or a timing information for a path, and the third information is at least one of: an SD vector, a CSI-RS port for reception, an azimuth angle of arrival (AoA), an angle of arrival (AoA), a zenith angle of arrival (ZoA), a beam for reception, an SD filter for reception.

In some example embodiments, the at least one first message may indicate at least one of the following: resources used for transmitting the second set of RSs, a set of transmission parameters used for transmitting the second set of RSs, a set of fourth information related to SD and used for transmitting the second set of RSs, or at least one second information related to FD or related to timing information of path.

In some example embodiments, the fourth information may be at least one of: an SD vector, a channel state information reference signal (CSI-RS) port, an azimuth angle of departure (AoD), an angle of departure (AoD), a zenith angle of departure (ZoD), a beam for transmission, an SD filter for transmission, the second information may be at least one of: an FD vector, or a timing information for a path.

In some example embodiments, the length of the fourth information may be based on the number of antenna ports of the first node configured to the second set of RSs or the number of antenna ports of the first node used for transmission.

In some example embodiments, the at least one third message may indicate at least one of the following: a set of fifth information related to SD and used for receiving the second set of RSs.

In some example embodiments, the fifth information may be at least one of: an SD vector, one channel state information reference signal (CSI-RS) port for reception, an azimuth angle of arrival (AoA), an angle of arrival (AoA), a zenith angle of arrival (ZoA), a beam for reception, an SD filter for reception.

In some example embodiments, the second set of RSs may be transmitted based on the first set of RSs.

In some example embodiments, the at least one second message may further indicate at least one of the following: a first location information of the first node, or a second location information of the second node.

In some example embodiments, the first location information may comprise at least one of a first horizontal direction information of an antenna panel of the first node or a first vertical direction information of the antenna panel of the first node; and the second location information may comprise at least one of a second horizontal direction information of an antenna panel of the second node or a second vertical direction information of the antenna panel of the second node.

In some example embodiments, the first and second location information may be mapped into a same coordinate system.

In some example embodiments, the second node may receive, from the first node, first capability-related information indicating whether a capability for the second message is supported by the first node, or transmit, to the function entity, second capability-related information indicating whether a capability for the third message is supported by the second node.

In some example embodiments, prior to receiving the first capability-related information, the second node may transmit a first request for the first capability-related information to the first node, or prior to transmitting the second capability-related information, receive a first second for the second capability-related information from the function entity.

In some example embodiments, the first node may be a terminal device or a network device, the second node may be a network device, and the function entity may be at least one of an access and mobility management function (AMF), an integrated sensing management function (ISMF), a sensing function (SF) or a location management function (LMF).

FIG. 9C illustrates a flowchart of a communication method 900C implemented at a function entity in accordance with some embodiments of the present disclosure. For the purpose of discussion, the method 900C will be described from the perspective of the function entity 185 in FIG. 1B.

At block 950, the function entity may transmit, to at least one of a first node or a second node, a first message for sensing.

At block 960, the function entity may receive, at least one of following: at least one second message comprising information used for sensing from the first node, the at least one second message being determined by the first node by measuring a first set of reference signals (RSs) transmitted by the second node; or at least one third message comprising information used for sensing, the at least one third message being determined by the second node by measuring a second set of RSs transmitted by the first node based on the at least one first message.

In some example embodiments, the function entity may determine, sensing results based on the at least one second message and/or the at least one third message; and transmit, the sensing results to at least one of the following: the first node, the second node, or a sensing service requester.

In some example embodiments, the function entity may receive, from the first node, first capability-related information indicating whether a capability for the second message is supported by the first node, or receive, from the second node, second capability-related information indicating whether a capability for the third message is supported by the second node.

In some example embodiments, prior to receiving the first capability-related information, the function entity may transmit a first request for the first capability-related information to the first node, or prior to receiving the second capability-related information, transmit a first second for the second capability-related information from the function entity.

In some example embodiments, the first node may be a terminal device or a network device, the second node may be a network device, and the function entity may be at least one of an access and mobility management function (AMF), an integrated sensing management function (ISMF), a sensing function (SF) or a location management function (LMF).

### Example Devices and Apparatuses

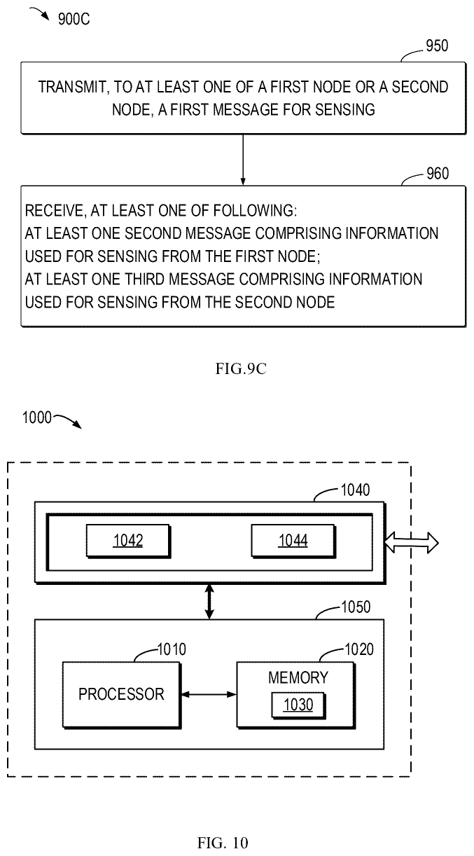

FIG. 10 is a simplified block diagram of a device 1000 that is suitable for implementing embodiments of the present disclosure. The device 1000 can be considered as a further example implementation of any of the devices as shown in FIG. 1A. Accordingly, the device 1000 can be implemented at or as at least a part of the first device 110 or the second device 120.

As shown, the device 1000 includes a processor 1010, a memory 1020 coupled to the processor 1010, a suitable transceiver 1040 coupled to the processor 1010, and a communication interface coupled to the transceiver 1040. The memory 1010 stores at least a part of a program 1030. The transceiver 1040 may be for bidirectional communications or a unidirectional communication based on requirements. The transceiver 1040 may include at least one of a transmitter 1042 and a receiver 1044. The transmitter 1042 and the receiver 1044 may be functional modules or physical entities. The transceiver 1040 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 1 to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

According to embodiments of the present disclosure, a first device comprising a circuitry is provided. The circuitry is configured to: receive, from a second device, first configuration information for at least one measurement report; and transmit, to the second device, based on the first configuration information, at least one measurement report indicating at least one of the following: a first set of first information related to spatial domain (SD), a second set of second information related to frequency domain (FD) or timing information for path, a third set of amplitude coefficients, a fourth set of phase coefficients, or a fifth set of timing information for a set of rays associated with one second information in the second set of second information, and wherein the at least one measurement report comprises at least one of: a first subset of information and a second subset of information, wherein the first or the second subset of information is applied for a calculation/report of precoder or channel quality indicator (CQI) or CSI or PMI, or a first measurement report and a second measurement report associated with the first measurement report. According to embodiments of the present disclosure, the circuitry may be configured to perform any method implemented by the first device as discussed above.

According to embodiments of the present disclosure, a second device comprising a circuitry is provided. The circuitry is configured to: transmit, to a first device, first configuration information for at least one measurement report; and receive, from the first device, based on the first configuration information, at least one measurement report indicating at least one of the following: a first set of first information related to spatial domain (SD), a second set of second information related to frequency domain (FD) or timing information for path, a third set of amplitude coefficients, a fourth set of phase coefficients, or a fifth set of timing information for a set of rays associated with one second information in the second set of second information, and wherein the at least one measurement report comprises at least one of: a first subset of information and a second subset of information, wherein the first or the second subset of information is applied for a calculation/report of precoder or channel quality indicator (CQI) or CSI or PMI, or a first measurement report and a second measurement report associated with the first measurement report. According to embodiments of the present disclosure, the circuitry may be configured to perform any method implemented by the second device as discussed above.

According to embodiments of the present disclosure, a first node comprising a circuitry is provided. The circuitry is configured to: receive, from a second node or a function entity, at least one first message for sensing; and perform, based on the at least one first message, at least one of the following: transmitting, at least one second message to at least one of the second node or the function entity, the at least one second message comprising information used for sensing, the at least one second message being determined by the first node by measuring a first set of reference signals (RSs) transmitted by the second node; or transmitting, to the second node, a second set of RSs to be measured by the second node to generate at least one third message comprising information used for sensing. According to embodiments of the present disclosure, the circuitry may be configured to perform any method implemented by the first node as discussed above.

According to embodiments of the present disclosure, a second node comprising a circuitry is provided. The circuitry is configured to: receive from a function entity or transmit to a first node, at least one first message for sensing; and perform at least one of the following: receiving, from the first node, at least one second message, the at least one second message comprising information used for sensing, the at least one second message being determined by the first node by measuring a first set of reference signals (RSS) transmitted by the second node; transmitting, to the first node or the function entity, at least one third message comprising information used for sensing, the at least one third message being determined by the second node by measuring a second set of RSs transmitted by the first node based on the at least one first message. According to embodiments of the present disclosure, the circuitry may be configured to perform any method implemented by the second node as discussed above.

According to embodiments of the present disclosure, a function entity comprising a circuitry is provided. The circuitry is configured to: transmit, to at least one of a first node or a second node, a first message for sensing; and receive, at least one of following: at least one second message comprising information used for sensing from the first node, the at least one second message being determined by the first node by measuring a first set of reference signals (RSs) transmitted by the second node; at least one third message comprising information used for sensing, the at least one third message being determined by the second node by measuring a second set of RSs transmitted by the first node based on the at least one first message. According to embodiments of the present disclosure, the circuitry may be configured to perform any method implemented by the function entity as discussed above.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following aspects.

In an aspect, it is proposed a first device comprising: a processor configured to cause the first device to: receive, from a second device, first configuration information for at least one measurement report; and transmit, to the second device, based on the first configuration information, at least one measurement report indicating at least one of the following: a first set of first information related to spatial domain (SD), a second set of second information related to frequency domain (FD) or timing information for path, a third set of amplitude coefficients, a fourth set of phase coefficients, or a fifth set of timing information for a set of rays associated with one second information in the second set of second information, and wherein the at least one measurement report comprises at least one of: a first subset of information and a second subset of information, wherein the first or the second subset of information is applied for a calculation/report of precoder or channel quality indicator (CQI) or PMI or CSI, or a first measurement report and a second measurement report associated with the first measurement report.

In some embodiments, the first information is at least one of: an SD vector, one channel state information reference signal (CSI-RS) port, an angle of departure, a zenith angle of departure (ZoD), an angle of a directional angle or a beam, and the second information is at least one of: an FD vector, or a timing information for a path.

In some embodiments, the first configuration information indicates at least one of the following: the number of first information comprised in the first set, the number of second information comprised in the second set, the number of amplitude coefficients, or the number of phase coefficients.

In some embodiments, each second information comprised in the second set is indicated by an absolute time value, or one of the second information comprised in the second set is indicated as reference second information and indicated by an absolute time value, and each of other second information is indicated by a differential time value between a time value of the other second information and the absolute time value.

In some embodiments, the second set of second information is indicated by: a set of FD vectors corresponding to the second set of second information, and an absolute time value corresponding to one of the set of FD vectors which is indicated as reference second information.

In some embodiments, the at least one measurement report further indicates the reference second information.

In some embodiments, the differential time value is indicated based on a quantization associated with at least one of the following: a size of frequency band for the at least one measurement report, a size of bandwidth part (BWP) for the at least one measurement report, or a size of sub-carrier space (SCS) for the at least one measurement report.

In some embodiments, the at least one measurement report is associated with at least two different functionalities and indicates: the first subset of information associated with a first functionality, and the second subset of information associated with a second functionality different from the first functionality.

In some embodiments, the first subset of information and the second subset of information are at least partially overlapped, the first subset of information is a subset of the second subset of information, or the second subset of information is a subset of the first subset of information.

In some embodiments, the first measurement report indicates a first subset of information associated with a first functionality and the second measurement report indicates a second subset of information associated a second functionality different from the first functionality, the first measurement report is used for the first functionality, and the second measurement report is used for the second functionality, or the first measurement report comprises a first portion of measurement results and the second measurement report comprises a second portion of the measurement results.

In some embodiments, the first measurement report comprises at least one of the following: a set of first information, a set of second information, or at least one set of ray information associated with respective second information comprised in the set of second information, and the second measurement report comprises at least one of the following: a selection of the first information comprised in the set of first information, or a selection of the second information comprised in the set of second information.

In some embodiments, transmitting the at least one measurement report comprises: receiving, from the second device, second configuration information indicating at least one first information and/or at least one second information; and transmitting, to the second device, a measurement report comprising measurement results about the at least one ray or at least one newly-detected ray associated with the at least one first information and/or at least one second information.

In some embodiments, the processor is further configured to cause the first device to: receive, from the second device, third configuration information indicating at least one of: a set of first information or a set of second information unapplicable for a specific functionality.

In some embodiments, the first configuration information further indicates at least one first antenna port and at least one second antenna port, and wherein the at least one first antenna port is configured with a first density in a frequency resource, and the at least one second antenna port is configured with a second density in the frequency resource, the second density being different from the first density, the at least one first antenna port is configured with a first size of transmission resource, and the at least one second antenna port is configured with a second size of transmission resource different from the first size of transmission resource, or the at least one first antenna port is used for a first functionality, and the at least one second antenna port is used for a second functionality different from the first functionality.

In some embodiments, the second information is associated with at least one of the following: a subset of the first set of first information, wherein the first information comprised in the subset of the first set of first information is adjacent, a subset of the third set of amplitude coefficients, a subset of the fourth set of phase coefficients, or a set of rays, each ray comprised in the set of rays being associated with at least one of the following: an amplitude coefficient, a phase coefficient, or a time value, wherein the time value is indicated by one of the following: a differential time value between the time value corresponding to the ray and a time value corresponding to the second information with which the set of rays associated, or a differential time value between the time value corresponding to the ray and a time value corresponding to reference second information.

In some embodiments, the at least one measurement report further indicates at least one of the following: the number second information that is associated with a set of rays, or the number rays comprised in the set of rays.

In some embodiments, different rays comprised in the set of rays are associated with different first information or different subsets of first information.

In some embodiments, the maximum number of rays comprised in the set of rays is smaller than or equal to a threshold number.

In some embodiments, the at least two different functionalities comprise a first functionality of sensing and a second functionality of communication.

In some embodiments, the first device is a terminal device and the second device is a network device.

In an aspect, it is proposed a second device comprising: a processor configured to cause the second device to: transmit, to a first device, first configuration information for at least one measurement report; and receive, from the first device, based on the first configuration information, at least one measurement report indicating at least one of the following: a first set of first information related to spatial domain (SD), a second set of second information related to frequency domain (FD) or timing information for path, a third set of amplitude coefficients, a fourth set of phase coefficients, or a fifth set of timing information for a set of rays associated with one second information in the second set of second information, and wherein the at least one measurement report comprises at least one of: a first subset of information and a second subset of information, wherein the first or the second subset of information is applied for a calculation/report of precoder or channel quality indicator (CQI) or PMI or CSI, or a first measurement report and a second measurement report associated with the first measurement report.

In some embodiments, the first information is at least one of: an SD vector, one channel state information reference signal (CSI-RS) port, an angle of departure, a zenith angle of departure (ZoD), an angle of a directional angle or a beam, and the second information is at least one of: an FD vector, or a timing information for a path.

In some embodiments, the first configuration information indicates at least one of the following: the number of first information comprised in the first set, the number of second information comprised in the second set, the number of amplitude coefficients, or the number of phase coefficients.

In some embodiments, each second information comprised in the second set is indicated by an absolute time value, or one of the second information comprised in the second set is indicated as reference second information and indicated by an absolute time value, and each of other second information is indicated by a differential time value between a time value of the other second information and the absolute time value.

In some embodiments, the second set of second information is indicated by: a set of FD vectors corresponding to the second set of second information, and an absolute time value corresponding to one of the set of FD vectors which is indicated as reference second information.

In some embodiments, the at least one measurement report further indicates the reference second information.

In some embodiments, the differential time value is indicated based on a quantization associated with at least one of the following: a size of frequency band for the at least one measurement report, a size of bandwidth part (BWP) for the at least one measurement report, or a size of sub-carrier space (SCS) for the at least one measurement report.

In some embodiments, the at least one measurement report is associated with at least two different functionalities and indicates: the first subset of information associated with a first functionality, and the second subset of information associated with a second functionality different from the first functionality.

In some embodiments, the first subset of information and the second subset of information are at least partially overlapped, the first subset of information is a subset of the second subset of information, or the second subset of information is a subset of the first subset of information.

In some embodiments, the first measurement report indicates a first subset of information associated with a first functionality and the second measurement report indicates a second subset of information associated a second functionality different from the first functionality, the first measurement report is used for the first functionality, and the second measurement report is used for the second functionality, or the first measurement report comprises a first portion of measurement results and the second measurement report comprises a second portion of the measurement results.

In some embodiments, the first measurement report comprises at least one of the following: a set of first information, a set of second information, or at least one set of ray information associated with respective second information comprised in the set of second information, and the second measurement report comprises at least one of the following: a selection of the first information comprised in the set of first information, or a selection of the second information comprised in the set of second information.

In some embodiments, transmitting the at least one measurement report comprises: receiving, from the second device, second configuration information indicating at least one first information and/or at least one second information; and transmitting, to the second device, a measurement report comprising measurement results about the at least one ray or at least one newly-detected ray associated with the at least one first information and/or at least one second information.

In some embodiments, the processor is further configured to cause the second device to: transmit, to the first device, third configuration information indicating at least one of: a set of first information or a set of second information unapplicable for a specific functionality.

In some embodiments, the first configuration information further indicates at least one first antenna port and at least one second antenna port, and wherein the at least one first antenna port is configured with a first density in a frequency resource, and the at least one second antenna port is configured with a second density in the frequency resource, the second density being different from the first density, the at least one first antenna port is configured with a first size of transmission resource, and the at least one second antenna port is configured with a second size of transmission resource different from the first size of transmission resource, or the at least one first antenna port is used for a first functionality, and the at least one second antenna port is used for a second functionality different from the first functionality.

In some embodiments, the second information is associated with at least one of the following: a subset of the first set of first information, wherein the first information comprised in the subset of the first set of first information is adjacent, a subset of the third set of amplitude coefficients, a subset of the fourth set of phase coefficients, or a set of rays, each ray comprised in the set of rays being associated with at least one of the following: an amplitude coefficient, a phase coefficient, or a time value, wherein the time value is indicated by one of the following: a differential time value between the time value corresponding to the ray and a time value corresponding to the second information with which the set of rays associated, or a differential time value between the time value corresponding to the ray and a time value corresponding to reference second information.

In some embodiments, the at least one measurement report further indicates at least one of the following: the number second information that is associated with a set of rays, or the number rays comprised in the set of rays.

In some embodiments, different rays comprised in the set of rays are associated with different first information or different subsets of first information.

In some embodiments, the maximum number of rays comprised in the set of rays is smaller than or equal to a threshold number.

In some embodiments, the at least two different functionalities comprise a first functionality of sensing and a second functionality of communication.

In some embodiments, the first device is a terminal device and the second device is a network device.

In an aspect, a first device comprises: at least one processor; and at least one memory coupled to the at least one processor and storing instructions thereon, the instructions, when executed by the at least one processor, causing the device to perform the method implemented by the first device discussed above.

In an aspect, a second device comprises: at least one processor; and at least one memory coupled to the at least one processor and storing instructions thereon, the instructions, when executed by the at least one processor, causing the device to perform the method implemented by the second device discussed above.

In an aspect, a computer readable medium having instructions stored thereon, the instructions, when executed on at least one processor, causing the at least one processor to perform the method implemented by the first device discussed above.

In an aspect, a computer readable medium having instructions stored thereon, the instructions, when executed on at least one processor, causing the at least one processor to perform the method implemented by the second device discussed above.

In an aspect, a computer program comprising instructions, the instructions, when executed on at least one processor, causing the at least one processor to perform the method implemented by the first device discussed above.

In an aspect, a computer program comprising instructions, the instructions, when executed on at least one processor, causing the at least one processor to perform the method implemented by the second device discussed above.

In an aspect, it is proposed a first node comprising: a processor configured to cause the first node to: receive, from a second node or a function entity, at least one first message for sensing; and perform, based on the at least one first message, at least one of the following: transmitting, at least one second message to at least one of the second node or the function entity, the at least one second message comprising information used for sensing, the at least one second message being determined by the first node by measuring a first set of reference signals (RSs) transmitted by the second node; or transmitting, to the second node, a second set of RSs to be measured by the second node to generate at least one third message comprising information used for sensing.

In some embodiments, the at least one second message indicates at least one of the following: a set of first information related to spatial domain (SD) and used for transmitting the first set of RSs, a set of second information related to frequency domain (FD) or related to timing information of path, a set of timing information for a set of rays associated with the second information in the set of second information, a set of third information related to SD and used for receiving the first set of RSs, a first set of non-zero coefficients corresponding to the set of first information, or a second set of non-zero coefficients corresponding to the set of third information.

In some embodiments, the first information is at least one of: an SD vector, a channel state information reference signal (CSI-RS) port, an azimuth angle of departure (AoD), an angle of departure (AoD), a zenith angle of departure (ZoD), a beam for transmission, an SD filter for transmission, the second information is at least one of: an FD vector, or a timing information for a path, and the third information is at least one of: an SD vector, a CSI-RS port for reception, an azimuth angle of arrival (AoA), an angle of arrival (AoA), a zenith angle of arrival (ZoA), a beam for reception, an SD filter for reception.

In some embodiments, the length of the first information is based on the number of antenna ports of the second node configured to the first set of RSs or the number of antenna ports of the second node used for transmission, and wherein the length of the third information is based on the number of antenna ports of the first node configured to the first set of RSs or the number of antenna ports of the first node for reception.

In some embodiments, the at least one first message indicates at least one of the following: resources used for transmitting the second set of RSs, a set of transmission parameters used for transmitting the second set of RSs, a set of fourth information related to SD and used for transmitting the second set of RSs, or at least one second information related to FD or related to timing information of path.

In some embodiments, the fourth information is at least one of: an SD vector, a channel state information reference signal (CSI-RS) port, an azimuth angle of departure (AoD), an angle of departure (AoD), a zenith angle of departure (ZoD), a beam for transmission, an SD filter for transmission, the second information is at least one of: an FD vector, or a timing information for a path.

In some embodiments, the length of the fourth information is based on the number of antenna ports of the first node configured to the second set of RSs or the number of antenna ports of the first node used for transmission.

In some embodiments, the at least one third message indicates at least one of the following: a set of fifth information related to SD and used for receiving the second set of RSs.

In some embodiments, the fifth information is at least one of: an SD vector, one channel state information reference signal (CSI-RS) port for reception, an azimuth angle of arrival (AoA), an angle of arrival (AoA), a zenith angle of arrival (ZoA), a beam for reception, an SD filter for reception.

In some embodiments, the second set of RSs is transmitted based on measurement of the first set of RSs.

In some embodiments, the at least one second message further indicates at least one of the following: a first location information of the first node, or a second location information of the second node.

In some embodiments, the first location information comprises at least one of a first three-dimensional coordinate of the first node, a first horizontal direction information of an antenna panel of the first node or a first vertical direction information of the antenna panel of the first node; and the second location information comprises at least one of a second three-dimensional coordinate of the first node, a second horizontal direction information of an antenna panel of the second node or a second vertical direction information of the antenna panel of the second node.

In some embodiments, the first and second location information is mapped into a same coordinate system.

In some embodiments, the processor is further configured to cause the first node to: transmit, to at least one of the second node or the function entity, first capability-related information indicating whether a capability for the second message is supported by the first node.

In some embodiments, the processor is further configured to cause the first node to: prior to transmitting the first capability-related information, receive a first request for the first capability-related information from the second node or the function entity.

In some embodiments, the first node is a terminal device or a network device, the second node is a network device, and the function entity is at least one of an access and mobility management function (AMF), an integrated sensing management function (ISMF), a sensing function (SF) or a location management function (LMF).

In an aspect, it is proposed a second node comprising: a processor configured to cause the second node to: receive from a function entity or transmit to a first node, at least one first message for sensing; and perform at least one of the following: receiving, from the first node, at least one second message, the at least one second message comprising information used for sensing, the at least one second message being determined by the first node by measuring a first set of reference signals (RSs) transmitted by the second node; transmitting, to the first node or the function entity, at least one third message comprising information used for sensing, the at least one third message being determined by the second node by measuring a second set of RSs transmitted by the first node based on the at least one first message.

In some embodiments, the at least one second message indicates at least one of the following: a set of first information related to spatial domain (SD) and used for transmitting the first set of RSs, a set of second information related to frequency domain (FD) or related to timing information of path, a set of timing information for a set of rays associated with the second information in the set of second information, a set of third information related to SD and used for receiving the first set of RSs, a first set of non-zero coefficients corresponding to the set of first information, or a second set of non-zero coefficients corresponding to the set of third information.

In some embodiments, the first information is at least one of: an SD vector, a channel state information reference signal (CSI-RS) port, an azimuth angle of departure (AoD), an angle of departure (AoD), a zenith angle of departure (ZoD), a beam for transmission, an SD filter for transmission, the second information is at least one of: an FD vector or a timing information for a path, and the third information is at least one of: an SD vector, a CSI-RS port for reception, an azimuth angle of arrival (AoA), an angle of arrival (AoA), a zenith angle of arrival (ZoA), a beam for reception, an SD filter for reception.

In some embodiments, the first information is at least one of: an SD vector, a channel state information reference signal (CSI-RS) port, an azimuth angle of departure (AoD), an angle of departure (AoD), a zenith angle of departure (ZoD), a beam for transmission, an SD filter for transmission, the second information is at least one of: an FD vector or a timing information for a path, and the third information is at least one of: an SD vector, a CSI-RS port for reception, an azimuth angle of arrival (AoA), an angle of arrival (AoA), a zenith angle of arrival (ZoA), a beam for reception, an SD filter for reception.

In some embodiments, the at least one first message indicates at least one of the following: resources used for transmitting the second set of RSs, a set of transmission parameters used for transmitting the second set of RSs, a set of fourth information related to SD and used for transmitting the second set of RSs, or at least one second information related to FD or related to timing information of path.

In some embodiments, the fourth information is at least one of: an SD vector, a channel state information reference signal (CSI-RS) port, an azimuth angle of departure (AoD), an angle of departure (AoD), a zenith angle of departure (ZoD), a beam for transmission, an SD filter for transmission, the second information is at least one of: an FD vector, or a timing information for a path.

In some embodiments, the length of the fourth information is based on the number of antenna ports of the first node configured to the second set of RSs or the number of antenna ports of the first node used for transmission.

In some embodiments, the at least one third message indicates at least one of the following: a set of fifth information related to SD and used for receiving the second set of RSs.

In some embodiments, the fifth information is at least one of: an SD vector, one channel state information reference signal (CSI-RS) port for reception, an azimuth angle of arrival (AoA), an angle of arrival (AoA), a zenith angle of arrival (ZoA), a beam for reception, an SD filter for reception.

In some embodiments, the second set of RSs is transmitted based on the first set of RSs.

In some embodiments, the at least one second message further indicates at least one of the following: a first location information of the first node, or a second location information of the second node.

In some embodiments, the first location information comprises at least one of a first horizontal direction information of an antenna panel of the first node or a first vertical direction information of the antenna panel of the first node; and the second location information comprises at least one of a second horizontal direction information of an antenna panel of the second node or a second vertical direction information of the antenna panel of the second node.

In some embodiments, the first and second location information is mapped into a same coordinate system.

In some embodiments, the processor is further configured to cause the second node to: receive, from the first node, first capability-related information indicating whether a capability for the second message is supported by the first node, or transmit, to the function entity, second capability-related information indicating whether a capability for the third message is supported by the second node.

In some embodiments, the processor is further configured to cause the second node to: prior to receiving the first capability-related information, transmit a first request for the first capability-related information to the first node, or prior to transmitting the second capability-related information, receive a first second for the second capability-related information from the function entity.

In some embodiments, the first node is a terminal device or a network device, the second node is a network device, and the function entity is at least one of an access and mobility management function (AMF), an integrated sensing management function (ISMF), a sensing function (SF) or a location management function (LMF).

In an aspect, it is proposed a function entity comprising: a processor configured to cause the function entity to: transmit, to at least one of a first node or a second node, a first message for sensing; and receive, at least one of following: at least one second message comprising information used for sensing from the first node, the at least one second message being determined by the first node by measuring a first set of reference signals (RSs) transmitted by the second node; at least one third message comprising information used for sensing, the at least one third message being determined by the second node by measuring a second set of RSs transmitted by the first node based on the at least one first message.

In some embodiments, the processor is further configured to cause the function entity to: determine, sensing results based on the at least one second message and/or the at least one third message; and transmit, the sensing results to at least one of the following: the first node, the second node, or a sensing service requester.

In some embodiments, the processor is further configured to cause the function entity to: receive, from the first node, first capability-related information indicating whether a capability for the second message is supported by the first node, or receive, from the second node, second capability-related information indicating whether a capability for the third message is supported by the second node.

In some embodiments, the processor is further configured to cause the function entity to: prior to receiving the first capability-related information, transmit a first request for the first capability-related information to the first node, or prior to receiving the second capability-related information, transmit a first second for the second capability-related information from the function entity.

In some embodiments, the first node is a terminal device or a network device, the second node is a network device, and the function entity is at least one of an access and mobility management function (AMF), an integrated sensing management function (ISMF), a sensing function (SF) or a location management function (LMF).

In an aspect, a first node comprises: at least one processor; and at least one memory coupled to the at least one processor and storing instructions thereon, the instructions, when executed by the at least one processor, causing the device to perform the method implemented by the first node discussed above.

In an aspect, a second node comprises: at least one processor; and at least one memory coupled to the at least one processor and storing instructions thereon, the instructions, when executed by the at least one processor, causing the device to perform the method implemented by the second node discussed above.

In an aspect, a function entity comprises: at least one processor; and at least one memory coupled to the at least one processor and storing instructions thereon, the instructions, when executed by the at least one processor, causing the device to perform the method implemented by the function entity discussed above.

In an aspect, a computer readable medium having instructions stored thereon, the instructions, when executed on at least one processor, causing the at least one processor to perform the method implemented by the first node discussed above.

In an aspect, a computer readable medium having instructions stored thereon, the instructions, when executed on at least one processor, causing the at least one processor to perform the method implemented by the second node discussed above.

In an aspect, a computer readable medium having instructions stored thereon, the instructions, when executed on at least one processor, causing the at least one processor to perform the method implemented by the function entity discussed above.

In an aspect, a computer program comprising instructions, the instructions, when executed on at least one processor, causing the at least one processor to perform the method implemented by the first node discussed above.

In an aspect, a computer program comprising instructions, the instructions, when executed on at least one processor, causing the at least one processor to perform the method implemented by the second node discussed above.

In an aspect, a computer program comprising instructions, the instructions, when executed on at least one processor, causing the at least one processor to perform the method implemented by the function entity discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-19. (canceled)

20. A method performed by a terminal device, the method comprising:
receiving, from a network device, a first configuration information of a first channel state information (CSI) report and a second CSI report, wherein the second CSI report is linked to the first CSI report, the first CSI report comprises at least one delay value;
receiving, from the network device, a second configuration information indicating whether the at least one delay value is used for the second CSI report; and
transmitting, to the network device, the first CSI report and the second CSI report.

21. The method of claim 20, further comprising:
determining the second CSI report based on the at least one delay value.

22. The method of claim 20, wherein the at least one delay value is determined based on at least one of a length of a cyclic prefix (CP) and a value of subcarrier spacing (SCS).

23. The method of claim 20, wherein the first CSI report and the second CSI report are transmitted in one reporting.

24. The method of claim 20, wherein the first CSI report is a latest CSI report transmitted before the second CSI report.

25. The method of claim 20, wherein a first antenna port and a first density are configured for the first CSI report, at least one second antenna port and a second density are configured for the second CSI report, the second density is smaller than the first density, the first density is 3.

26. The method of claim 20, wherein the first configuration information indicates a number of the at least one delay value.

27. The method of claim 20, wherein the first CSI report comprises an index of a reference channel state information-reference signal (CSI-RS) port in a set of CSI-RS ports, the at least one delay value corresponds to at least one CSI-RS port except the reference CSI-RS port, wherein a number of the set of CSI-RS ports is 2, 3 or 4.

28. The method of claim 20, wherein the second CSI report comprises a channel quality indicator (CQI), a precoding matrix indicator (PMI) and an indication of a number of layers.

29. The method of claim 20, further comprising:
transmitting, to the network device, a third CSI report comprising at least one phase value.

30. A method performed by a network device, the method comprising:
transmitting, to a terminal device, a first configuration information of a first channel state information (CSI) report and a second CSI report, wherein the second CSI report is linked to the first CSI report, the first CSI report comprises at least one delay value;
transmitting, to the terminal device, a second configuration information indicating whether the at least one delay value is used for the second CSI report; and
receiving, from the terminal device, the first CSI report and the second CSI report.

31. The method of claim 30, wherein the at least one delay value is determined based on at least one of a length of a cyclic prefix (CP) and a value of subcarrier spacing (SCS).

32. The method of claim 30, wherein the first CSI report and the second CSI report are transmitted in one reporting.

33. The method of claim 30, wherein the first CSI report is a latest CSI report transmitted before the second CSI report.

34. The method of claim 30, wherein a first antenna port and a first density are configured for the first CSI report, at least one second antenna port and a second density are configured for the second CSI report, the second density is smaller than the first density, the first density is 3.

35. The method of claim 30, wherein the first configuration information indicates a number of the at least one delay value.

36. The method of claim 30, wherein the first CSI report comprises an index of a reference channel state information-reference signal (CSI-RS) port in a set of CSI-RS ports, the at least one delay value corresponds to at least one CSI-RS port except the reference CSI-RS port, wherein a number of the set of CSI-RS ports is 2, 3 or 4.

37. The method of claim 30, wherein the second CSI report comprises a channel quality indicator (CQI), a precoding matrix indicator (PMI) and an indication of a number of layers.

38. The method of claim 30, further comprising:
receiving, from the terminal device, a third CSI report comprising at least one phase value.

39. A terminal device, comprising:
a processor configured to cause the terminal device to:
receive, from a network device, a first configuration information of a first channel state information (CSI) report and a second CSI report, wherein the second CSI report is linked to the first CSI report, the first CSI report comprises at least one delay value;
receive, from the network device, a second configuration information indicating whether the at least one delay value is used for the second CSI report; and
transmit, to the network device, the first CSI report and the second CSI report.
